(19) United States
(12) Patent Application Publication
(10) Pub. No.: US 2026/0197897 A1
(43) Pub. Date: Jul. 9, 2026

(54) TERMINAL APPARATUS, METHOD, AND INTEGRATED CIRCUIT

(71) Applicant: SHARP KABUSHIKI KAISHA, Sakai City, Osaka (JP)

(72) Inventors: Takuma KAWANO, Sakai City, Osaka (JP); Hidekazu TSUBOI, Sakai City, Osaka (JP); Shohei YAMADA, Sakai City, Osaka (JP); Taichi MIYAKE, Sakai City, Osaka (JP); Kyosuke INOUE, Sakai City, Osaka (JP); Takaki NOMURA, Sakai City, Osaka (JP)

(21) Appl. No.: 19/146,456

(22) PCT Filed: Dec. 6, 2023
(86) PCT No.: PCT/JP2023/043678

§ 371 Date: Jul. 8, 2025

(30) Foreign Application Priority Data
Aug. 3, 2023 (JP) 2023-127011

(51) Int. Cl. H04W 76/27; H04W 28/18

(52) U.S. Cl. CPC H04W 76/27; H04W 28/18

(57) ABSTRACT

A terminal apparatus in communication with a base station apparatus receives, from the base station apparatus, an RRC message including an information element related to reconfiguration with synchronization, performs the reconfiguration with synchronization in accordance with the RRC message, and transmits, to a higher layer, an indication to trigger release of a PC5 unicast link based on a determination that at least two conditions are satisfied. The two conditions are (a) the terminal apparatus is acting as a remote terminal apparatus, and (b) multi-path is not configured.

### TECHNICAL FIELD

The present invention relates to a terminal apparatus, a method, and an integrated circuit.

This application claims priority to JP 2023-127011 filed on Aug. 3, 2023, the contents of which are incorporated herein by reference.

### BACKGROUND ART

In the 3rd Generation Partnership Project (3GPP [trade name]) being a standardization project for cellular mobile communication systems, technical study and standardization are being carried out regarding cellular mobile communication systems including radio access, core networks, and services.

For example, technical study and standardization of Evolved Universal Terrestrial Radio Access (E-UTRA) have begun in the 3GPP as a Radio Access Technology (RAT) for cellular mobile communication systems for the 3.9th generation and the 4th generation. Technical study and standardization of enhanced technology of E-UTRA are still carried out in the 3GPP. Note that E-UTRA may also be referred to as Long TermEvolution (LTE: trade name), and its enhanced technology may also be referred to as LTE-Advanced (LTE-A) and LTE-Advanced Pro (LTE-A Pro).

Technical study and standardization of New Radio or NR Radio access (NR) have begun in the 3GPP as a Radio Access Technology (RAT) for cellular mobile communication systems for the 5th Generation (5G). Technical study and standardization of enhanced technology of NR are still carried out in the 3GPP.

### CITATION LIST

### Non Patent Literature

NPL 1: 3GPP TS 38.331 v17.3.0, “Evolved Universal Terrestrial Radio Access (E-UTRA); Radio Resource Control (RRC); Protocol specifications” pp. 70-116, pp. 218-223, pp. 316-1107
NPL 2: 3GPP TS 38.321 v17.2.0, “NR, Medium Access Control (MAC) protocol specification” pp. 17-104
NPL 3: 3GPP TS 38.213 v17.1.0 “NR; Physical layer procedures for control” pp. 14-20
NPL 4: 3GPP TS 38.300 v17.2.0, “NR; NR and NG-RAN Overall Description; Stage 2”
NPL 5: 3GPP TS 38.351 v17.1.0, “NR; Sidelink Relay Adaptation Protocol (SRAP) Specification”

### SUMMARY OF INVENTION

### Technical Problem

In the 3GPP, as an extended technique of NR, a technique called a sidelink (SL) has been under study in which terminal apparatuses directly communicate with each other without an intervening core network. In addition, a technique referred to as a UE-to-Network relay (U2N Relay) has been under study in which a terminal apparatus communicates with a base station apparatus via a relay terminal apparatus providing communication by the sidelink. Further, a study of a technique referred to as a Multi-path Relay has been started. In the multi-path relay, communication with a base station apparatus is performed using two types (or multiple) paths including an indirect path for communicating with the base station apparatus using a U2N relay and a direct path for direct communication with the base station apparatus without using the U2N relay.

An aspect of the present invention is made in view of the circumstances described above, and has an object to provide a terminal apparatus, a base station apparatus, a communication method, and an integrated circuit that enable efficient communication control.

### Solution to Problem

In order to accomplish the object described above, an aspect of the present invention is contrived to provide the following means. Specifically, an aspect of the present invention is a terminal apparatus for communicating with a base station apparatus, the terminal apparatus including a receiver configured to receive an RRC message from the base station apparatus, and a processing unit, wherein the processing unit configures a special cell in accordance with a dedicated configuration of the special cell included in the RRC message, based on a determination that one or both of two conditions are unsatisfied, the dedicated configuration of the special cell corresponds to a configuration being for the special cell and a configuration dedicated to the terminal apparatus, and the two conditions are (a) the terminal apparatus is acting as a remote terminal apparatus, and (b) multi-path is not configured.

An aspect of the present invention is a method of a terminal apparatus for communicating with a base station apparatus, the method including the steps of receiving an RRC message from the base station apparatus, and configuring a special cell in accordance with a dedicated configuration of the special cell included in the RRC message, based on a determination that one or both of two conditions are unsatisfied, wherein the dedicated configuration of the special cell corresponds to a configuration being for the special cell and a configuration dedicated to the terminal apparatus, and the two conditions are (a) the terminal apparatus is acting as a remote terminal apparatus, and (b) multi-path is not configured.

An aspect of the present invention is an integrated circuit implemented in a terminal apparatus for communicating with a base station apparatus, the integrated circuit including a function of receiving an RRC message from the base station apparatus, and a function of configuring a special cell in accordance with a dedicated configuration of the special cell included in the RRC message, based on a determination that one or both of two conditions are unsatisfied, wherein the dedicated configuration of the special cell corresponds to a configuration being for the special cell and a configuration dedicated to the terminal apparatus, and the two conditions are (a) the terminal apparatus is acting as a remote terminal apparatus, and (b) multi-path is not configured.

Note that these comprehensive or specific aspects may be implemented in a system, an apparatus, a method, an integrated circuit, a computer program, or a recording medium, or may be implemented in any combination of systems, apparatuses, methods, integrated circuits, computer programs, and recording media.

### Advantageous Effects of Invention

According to an aspect of the present invention, the terminal apparatus, the method, and the integrated circuit can implement efficient communication control processing.

### BRIEF DESCRIPTION OF DRAWINGS

FIG. 1 is a schematic diagram of a communication system according to the present embodiment.

FIG. 2 is a diagram of an example of a protocol structure in NR sidelink communication according to the present embodiment.

FIG. 3 is a diagram of an example of the protocol structure in the NR sidelink communication according to the present embodiment.

FIG. 4 is a diagram of an example of a protocol structure in a discovery procedure according to the present embodiment.

FIG. 5 is a block diagram illustrating a configuration of a terminal apparatus according to the present embodiment.

FIG. 6 is a block diagram illustrating a configuration of a base station apparatus according to the present embodiment.

FIG. 7 is a diagram of an example of a protocol structure in NR according to the present embodiment.

FIG. 8 is a diagram of an example of a protocol structure of a control plane of an L2 U2N relay according to the present embodiment.

FIG. 9 is a diagram of an example of a protocol structure of a user plane of the L2 U2N relay according to the present embodiment.

FIG. 10 is an example of processing according to the present embodiment.

### DESCRIPTION OF EMBODIMENTS

The present embodiment will be described below in detail with reference to the drawings.

Note that, in the present embodiment, terms of each node and entity, processing in each node and entity, and the like in a case that the radio access technology is NR will be described. However, the present embodiment may be applied to another radio access technology. In the present embodiment, the terms of each node and entity may be other terms.

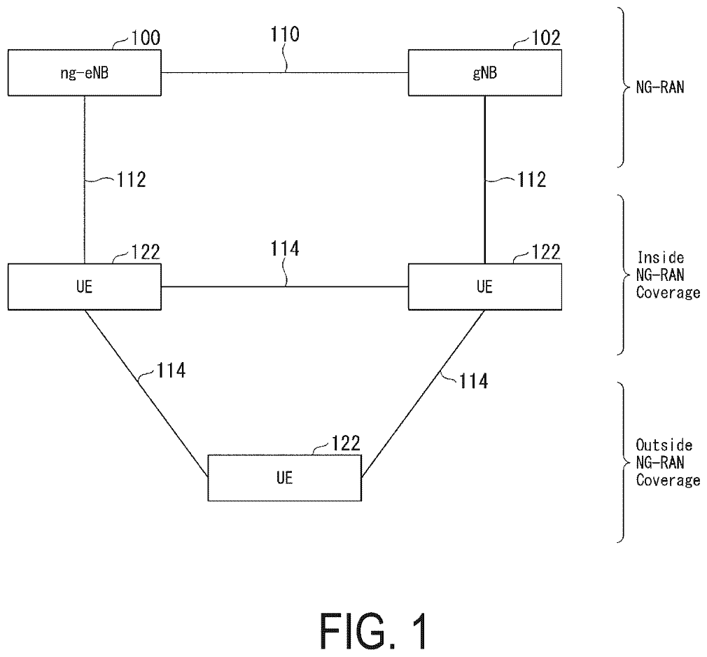

FIG. 1 is a schematic diagram of a communication system according to the present embodiment. Note that functions such as each node, radio access technology, core network, and interface to be described with reference to FIG. 1 are a part of functions closely related to the present embodiment, and other functions may be provided.

E-UTRA may be a radio access technology. The E-UTRA may be an air interface between a UE 122 and an ng-eNB 100. The air interface 112 between the UE 122 and the ng-eNB 100 may be referred to as a Uu interface. The ng E-UTRAN Node B (ng-eNB) 100 may be a base station apparatus of the E-UTRAN. The ng-eNB 100 may have an E-UTRA protocol to be described below. The E-UTRA protocol may include an E-UTRA User Plane (UP) protocol to be described below and an E-UTRA Control Plane (CP) protocol to be described below. The ng-eNB 100 may terminate the E-UTRA user plane protocol and the E-UTRA control plane protocol for the UE 122. A radio access network including the eNB may be referred to as an E-UTRAN.

NR may be a radio access technology. The NR may be an air interface between the UE 122 and a gNB 102. The air interface 112 between the UE 122 and the gNB 102 may be referred to as a Uu interface. The g Node B (gNB) 102 may be a base station apparatus of NR. The gNB 102 may have an NR protocol to be described below. The NR protocol may include an NR User Plane (UP) protocol to be described below and an NR Control Plane (CP) protocol to be described below. The gNB 102 may terminate the NR user plane protocol and the NR control plane protocol for the UE 122.

Note that the interface 110 between the ng-eNB 100 and the gNB 102 may be referred to as an Xn interface. The ng-eNB and the gNB may be connected to the 5GC via an interface called an NG interface (not illustrated). The 5GC may be a core network. One or multiple base station apparatuses may connect to the 5GC via the NG interface.

A state in which connection to the base station apparatus only via the Uu interface is enabled may be referred to as Inside NG-RAN Coverage or In-Coverage (IC). A state in which connection to the base station apparatus only via the Uu interface is disabled may be referred to as Outside NG-RAN Coverage or Out-of-Coverage (OoC). The air interface 114 between the UE 122 and the UE 122 may be referred to as a PC5 interface. Communication between the UEs 122 via the PC5 interface may be referred to as sidelink (SL) communication. A terminal apparatus that can perform sidelink communication may be referred to as a terminal apparatus capable of sidelink communication.

Note that, in the following description, the ng-eNB 100 and/or the gNB 102 is also simply referred to as a base station apparatus, and the UE 122 is also simply referred to as a terminal apparatus or a UE. The PC5 interface is also simply referred to as PC5, and the Uu interface is also simply referred to as Uu.

The sidelink is a technique for performing direct communication between terminal apparatuses via the PC5, and sidelink transmission and/or reception on the PC5 is performed inside the NG-RAN coverage and outside the NG-RAN coverage.

The NR SL communication has three transmission modes, and the SL communication is performed in one of the transmission modes with a pair of a Source Layer-2 identifier (Source Layer-2 (L2) ID) and a Destination Layer-2 identifier (Destination Layer-2 (L2) ID). The source layer-2 identifier and the destination layer-2 identifier may be referred to as a source L2ID and a destination L2ID, respectively. The three transmission modes are “Unicast transmission”, “Groupcast transmission”, and “Broadcast transmission”. Note that the transmission mode may be referred to as a cast type or the like. Note that unicast transmission of direct communication is supported on the PC5, and a PC5 unicast link between two UEs may be established for direct communication. The PC5 unicast link may be maintained, modified, or released according to application-layer requirements or communication requirements.

Unicast transmission is characterized by (1) support of one PC5-RRC connection between paired UEs, (2) transmission and/or reception of control information and user traffic between UEs on a sidelink, (3) support of sidelink HARQ feedback, (4) transmit power control on the sidelink, (5) support of RLC AM, and (6) detection of a failure in radio link for PC5-RRC connection.

Groupcast transmission is characterized by (1) transmission and/or reception of user traffic between UEs belonging to a sidelink group and (2) support of sidelink HARQ feedback.

Broadcast transmission is characterized by (1) transmission and/or reception of user traffic between UEs on the sidelink.

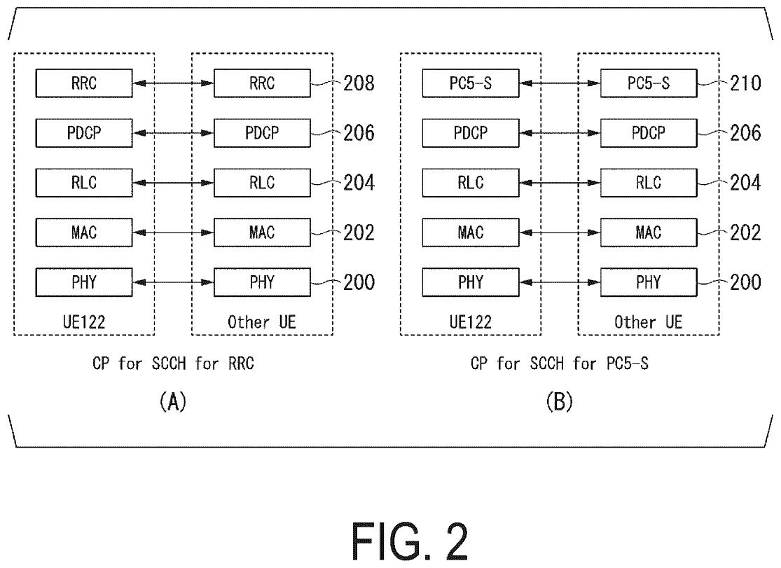

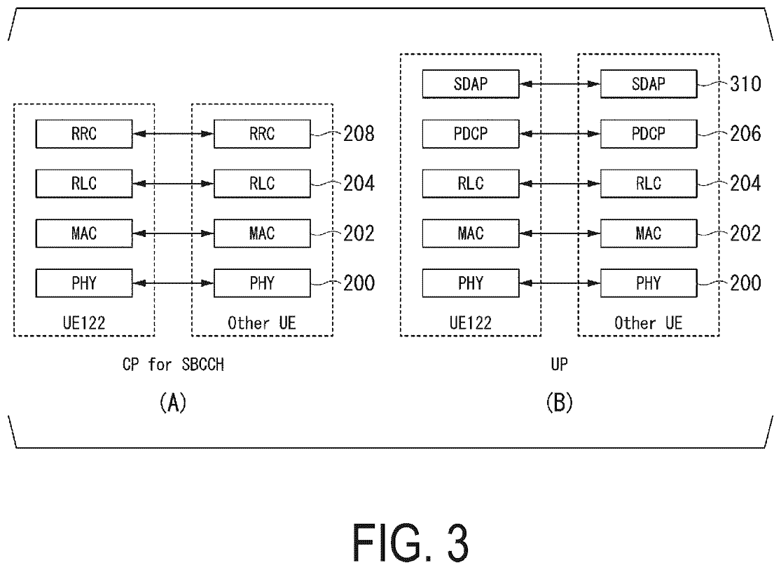

FIG. 2 and FIG. 3 are diagrams of an example of a protocol structure in NR sidelink communication according to the present embodiment. Note that functions of each protocol to be described with reference to FIG. 2 and/or FIG. 3 are a part of functions closely related to the present embodiment, and other functions may be provided. Note that, in the present embodiment, the sidelink (SL) may be a link between a terminal apparatus and a terminal apparatus.

FIG. 2(A) is a diagram of a protocol stack of the Control Plane (CP) for an SCCH with RRC, which is configured on the PC5 interface. As illustrated in FIG. 2(A), the control plane protocol stack for the SCCH with RRC may include a Physical layer (PHY) 200 which is a radio physical layer, a Medium Access Control (MAC) 202 which is a medium access control layer, a Radio Link Control (RLC) 204 which is a radio link control layer, and a Packet Data Convergence Protocol (PDCP) 206 which is a packet data convergence protocol layer, and a Radio Resource Control (RRC) 208 which is a radio resource control layer. FIG. 2(B) is a diagram of the protocol stack of the control plane for the SCCH with PC5-S, which is configured on the PC5 interface. As illustrated in FIG. 2(B), the control plane protocol stack for the SCCH with PC5-S may include the Physical layer (PHY) 200 which is a radio physical layer, the Medium Access Control (MAC) 202 which is a medium access control layer, the Radio Link Control (RLC) 204 which is a radio link control layer, and the Packet Data Convergence Protocol (PDCP) 206 which is a packet data convergence protocol layer, and a PC5 Signalling (PC5-S) 210 which is a PC5 signalling layer.

FIG. 3(A) is a diagram of the protocol stack of the control plane for an SBCCH, which is configured on the PC5 interface. As illustrated in FIG. 3(A), the control plane protocol stack for the SBCCH may include the Physical layer (PHY) 200 which is a radio physical layer, the Medium Access Control (MAC) 202 which is a medium access control layer, the Radio Link Control (RLC) 204 which is a radio link control layer, and the Radio Resource Control 208 (RRC) which is a radio resource control layer. FIG. 3(B) is a diagram of the protocol stack of the User Plane (UP) for an STCH, which is configured on the PC5 interface. As illustrated in FIG. 3(B), the control plane protocol stack for the STCH may include the Physical layer (PHY) 200 which is a radio physical layer, the Medium Access Control (MAC) 202 which is a medium access control layer, the Radio Link Control (RLC) 204 which is a radio link control layer, the Packet Data Convergence Protocol (PDCP) 206 which is a packet data convergence protocol layer, and a Service Data Adaptation Protocol (SDAP) 310 which is a service data adaptation protocol layer.

Note that an Access Stratum (AS) layer may be a layer including a part or all of the PHY 200, the MAC 202, the RLC 204, the PDCP 206, the SDAP 310, and the RRC 208. The PC5-S 210 and a Discovery 400 described below may be layers higher than the AS layer.

Note that the present embodiment may use terms such as a PHY (PHY layer), a MAC (MAC layer), an RLC (RLC layer), a PDCP (PDCP layer), an SDAP (SDAP layer), an RRC (RRC layer), and a PC5-S (PC5-S layer). In this case, the PHY (PHY layer), the MAC (MAC layer), the RLC (RLC layer), the PDCP (PDCP layer), the SDAP (SDAP layer), the RRC (RRC layer), and the PC5-S (PC5-S layer) may respectively be the PHY (PHY layer), the MAC (MAC layer), the RLC (RLC layer), the PDCP (PDCP layer), the SDAP (SDAP layer), the RRC (RRC layer), and the PC5-S (PC5-S layer) of the NR sidelink protocol. Note that, in a case that sidelink communication is performed using the E-UTRA technology, the SDAP layer may not be provided. Note that, in order to clarify that the protocol is used for the sidelink, for example, the RLC may be expressed as a sidelink RLC, an SL RLC, a PC5 RLC, or the like, and other protocols may also be expressed as protocols for the sidelink by prefixing “sidelink”, “SL”, or “PC5”.

In the present embodiment, in a case that the protocol of E-UTRA and the protocol of NR are distinguished from each other, the PHY, the MAC, the RLC, the PDCP, and the RRC may be hereinafter respectively referred to as the PHY for E-UTRA or the PHY for LTE, the MAC for E-UTRA or the MAC for LTE, the RLC for E-UTRA or the RLC for LTE, the PDCP for E-UTRA or the PDCP for LTE, and the RRC for E-UTRA or the RRC for LTE. The PHY, the MAC, the RLC, the PDCP, and the RRC may respectively be referred to as an E-UTRA PHY or an LTE PHY, an E-UTRA MAC or an LTE MAC, an E-UTRA RLC or an LTE RLC, an E-UTRA PDCP or an LTE PDCP, an E-UTRA RRC or an LTE RRC, and the like. In a case that the protocol of E-UTRA and the protocol of NR are distinguished from each other, the PHY, the MAC, the RLC, the PDCP, and the RRC may respectively be referred to as a PHY for NR, a MAC for NR, an RLC for NR, an RLC for NR, and an RRC for NR. The PHY, the MAC, the RLC, the PDCP, and the RRC may respectively be referred to as an NR PHY, an NR MAC, an NR RLC, an NR PDCP, an NR RRC, and the like.

Entities in the AS layer of E-UTRA, NR, and/or sidelink will be described. An entity having a part or all of functions of the physical layer may be referred to as a PHY entity. An entity having a part or all of functions of the MAC layer may be referred to as a MAC entity. An entity having a part or all of functions of the RLC layer may be referred to as an RLC entity. An entity having a part or all of functions of the PDCP layer may be referred to as a PDCP entity. An entity having a part or all of functions of the SDAP layer may be referred to as an SDAP entity. An entity having a part or all of functions of the RRC layer may be referred to as an RRC entity. The PHY entity, the MAC entity, the RLC entity, the PDCP entity, the SDAP entity, and the RRC entity may respectively be replaced with a PHY, a MAC, an RLC, a PDCP, an SDAP, and an RRC. Each entity in the AS layer may be an entity common to the E-UTRA, the NR, and/or the sidelink, or may be an independent entity.

Note that data provided from the MAC, the RLC, the PDCP, and the SDAP to a lower layer, and/or data provided to the MAC, the RLC, the PDCP, and the SDAP from a lower layer may be referred to as a MAC Protocol Data Unit (PDU), an RLC PDU, a PDCP PDU, and an SDAP PDU, respectively. Data provided to the MAC, the RLC, the PDCP, and the SDAP from a higher layer, and/or data provided from the MAC, the RLC, the PDCP, and the SDAP to a higher layer may be referred to as a MAC Service Data Unit (SDU), an RLC SDU, a PDCP SDU, and an SDAP SDU, respectively. A segmented RLC SDU may be referred to as an RLC SDU segment.

Here, the base station apparatus and the terminal apparatus exchange (transmit and/or receive) signals with each other in a higher layer (higherlayer) on the Uu interface. The higher layer may be referred to as an upper layer, and may be paraphrased with each other. For example, the base station apparatus and the terminal apparatus may transmit and/or receive an RRC message (also referred to as RRC signalling) in the Radio Resource Control (RRC) layer. In the Medium Access Control (MAC) layer, the base station apparatus and the terminal apparatus may transmit and/or receive a MAC Control Element (MAC CE). Additionally, the RRC layer of the terminal apparatus acquires system information broadcast from the base station apparatus. In this regard, the RRC message, the system information, and/or the MAC control element are also referred to as higher layer signalling (higher layer signaling) or a higher layer parameter. Each of the parameters included in the higher layer signalling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, an RLC layer, a PDCP layer, a Non Access Stratum (NAS) layer, and the like. For example, in the processing of the MAC layer, the higher layer may mean one or multiple of the RRC layer, the RLC layer, the PDCP layer, the NAS layer, and the like.

On the PC5 interface, the terminal apparatuses exchange (transmit and/or receive) signals with each other in higher layers. The terminal apparatuses may transmit and/or receive an RRC message (also referred to as RRC signalling) in the Radio Resource Control (RRC) layer. In the Medium Access Control (MAC) layer, the terminal apparatuses may transmit and/or receive a MAC Control Element (MAC CE). In this regard, the RRC message and/or the MAC control element are also referred to as higher layer signalling (higher layer signaling) or a higher layer parameter. Each of the parameters included in the higher layer signalling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, the RLC layer, the PDCP layer, the PC5-S layer, the Discovery layer, and the like. For example, in the processing of the MAC layer, the higher layer may mean one or multiple of the RRC layer, the RLC layer, the PDCP layer, the PC5-S layer, the Discovery layer, and the like.

Hereinafter, “A is given (provided) in the higher layer” or “A is given (provided) by the higher layer” may mean that the higher layer (mainly the RRC layer, the MAC layer, or the like) of the terminal apparatus receives A from the base station apparatus or another terminal apparatus, and that the received A is given (provided) from the higher layer of the terminal apparatus to the physical layer of the terminal apparatus. For example, “a higher layer parameter being provided” in the terminal apparatus may mean that higher layer signalling is received from the base station apparatus or another terminal apparatus, and a higher layer parameter included in the received higher layer signalling is provided from the higher layer of the terminal apparatus to the physical layer of the terminal apparatus. A higher layer parameter being configured for the terminal apparatus may mean that the higher layer parameter is given (provided) to the terminal apparatus. For example, a higher layer parameter being configured for the terminal apparatus may mean that the terminal apparatus receives higher layer signalling from the base station apparatus or another terminal apparatus and configures the received higher layer parameter in the higher layer. However, a higher layer parameter being configured for the terminal apparatus may include a default parameter given in advance being configured in the higher layer of the terminal apparatus. In description of transmission of an RRC message from the terminal apparatus to the base station apparatus or another terminal apparatus, the expression that a message is submitted from the RRC entity of the terminal apparatus to a lower layer may be used. In the terminal apparatus, “submitting a message to a lower layer” from the RRC entity may mean submitting a message to the PDCP layer. In the terminal apparatus, “submitting a message to a lower layer” from the RRC layer may mean submitting the message of the RRC to a PDCP entity corresponding to each SRB (SRB0, SRB1, SRB2, SRB3, or the like) because the message is transmitted using the SRB. In a case that the RRC entity of the terminal apparatus receives an indication from the lower layer, the lower layer may mean one or multiple of the PHY layer, the MAC layer, the RLC layer, the PDCP layer, and the like.

An example of the functions of the PHY will be described. The PHY of the terminal apparatus may have a function of transmitting and/or receiving transmitted data to and/or from the PHY of another terminal apparatus via a sidelink (SL) Physical Channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Now, the physical channels will be described. The physical channels used for radio communication between the terminal apparatus and another terminal apparatus may include the following physical channels.
Physical Sidelink Broadcast CHannel (PSBCH)
Physical Sidelink Control CHannel (PSCCH)
Physical Sidelink Shared CHannel (PSSCH)
Physical Sidelink Feedback CHannel (PSFCH)

The PSBCH may be used to broadcast system information required by the terminal apparatus.

The PSCCH may be used to indicate resources or other transmission parameters for the PSSCH.

The PSSCH may be used to transmit data and control information related to HARQ/CSI feedback to another terminal apparatus.

The PSFCH may be used to carry HARQ feedback to another terminal apparatus.

An example of the functions of the MAC will be described. The MAC may be referred to as a MAC sublayer. The MAC may have a function of mapping various Logical Channels to their corresponding transport channels. The logical channel may be identified with a Logical Channel Identity (or Logical Channel ID). The MAC may be connected to an upper RLC with a logical channel. The logical channel may be classified into a control channel for transmitting control information and a traffic channel for transmitting user information depending on the type of information to be transmitted. The MAC may have a function of multiplexing MAC SDUs belonging to one or multiple different logical channels and providing the multiplexed MAC SDUs to the PHY. The MAC may have a function of demultiplexing the MAC PDUs provided from the PHY and providing the demultiplexed MAC PDUs to a higher layer via the logical channels to which the respective MAC SDUs belong. The MAC may have a function of performing error correction through a Hybrid Automatic Repeat reQuest (HARQ). The MAC may have a function of reporting scheduling information. The MAC may have a function of performing priority processing among the terminal apparatuses by using dynamic scheduling. The MAC may have a function of performing priority processing among the logical channels in one terminal apparatus. The MAC may have a function of performing priority processing of resources overlapping in one terminal apparatus. The E-UTRA MAC may have a function of identifying Multimedia Broadcast Multicast Services (MBMS). The NR MAC may have a function of identifying a Multicast Broadcast Service (MBS). The MAC may have a function of selecting a transport format. The MAC may have a function of performing Discontinuous Reception (DRX) and/or Discontinuous Transmission (DTX), a function of performing a Random Access (RA) procedure, a Power Headroom Report (PHR) function of indicating information of transmittable power, a Buffer Status Report (BSR) function of indicating data volume information of a transmission buffer, and the like. The NR MAC may have a Bandwidth Adaptation (BA) function. A MAC PDU format used in the E-UTRA MAC and a MAC PDU format used in the NR MAC may be different from each other. The MAC PDU may include a MAC control element (MAC CE) being an element for performing control in the MAC.

The MAC sublayer may additionally provide, on the PC5 interface, services and functions, such as radio resource selection for selecting a radio resource for sidelink transmission, filtering of packets received through sidelink communication, priority processing between the uplink and the sidelink, reporting of Sidelink Channel State Information (Sidelink CSI).

Mapping, which is used in E-UTRA and/or NR, between a sidelink (SL) logical channel and a sidelink logical channel and a transport channel will be described.

A Sidelink Broadcast Control Channel (SBCCH) may be a sidelink logical channel for broadcasting sidelink system information from one terminal apparatus to one or multiple terminal apparatuses. The SBCCH may be mapped to an SL-BCH that is a sidelink transport channel.

A Sidelink Control Channel (SCCH) may be a sidelink logical channel for transmitting control information such as a PC5-RRC message and a PC5-S message from one terminal apparatus to one or multiple terminal apparatuses. The SCCH may be mapped to an SL-SCH that is a sidelink transport channel.

A Sidelink Traffic Control Channel (STCH) may be a sidelink logical channel for transmitting user information from one terminal apparatus to one or multiple terminal apparatuses. The STCH may be mapped to the SL-SCH that is a sidelink transport channel.

An example of the functions of the RLC will be described. The RLC may be referred to as an RLC sublayer. The E-UTRA RLC may have a function of segmenting (Segmentation) and/or concatenating (Concatenation) data provided from the PDCP of a higher layer, and providing the segmented and/or concatenated data to a lower layer. The E-UTRA RLC may have a function of reassembling (reassembly) and re-ordering data provided from a lower layer, and providing the reassembled and re-ordered data to a higher layer. The NR RLC may have a function of assigning data provided from the PDCP of a higher layer with a sequence number independent of a sequence number assigned in the PDCP. The NR RLC may have a function of segmenting (Segmentation) data provided from the PDCP and providing the segmented data to a lower layer. The NR RLC may have a function of reassembling (reassembly) data provided from a lower layer, and providing the reassembled data to a higher layer. The RLC may have a data retransmission function and/or retransmission request function (AutomaticRepeat reQuest (ARQ)). The RLC may have a function of performing error correction using the ARQ. Control information that indicates data required to be retransmitted and that is transmitted from a receiving side to a transmitting side of the RLC in order to perform the ARQ may be referred to as a status report. A status report transmission indication transmitted from the transmitting side to the receiving side of the RLC may be referred to as a poll. The RLC may have a function of detecting data duplication. The RLC may have a function of discarding data. The RLC may have three modes, namely a Transparent Mode (TM), an Unacknowledged Mode (UM), and an Acknowledged Mode (AM). In the TM, segmentation of data received from a higher layer may not be performed, and addition of an RLC header need not be performed. A TM RLC entity may be a uni-directional entity, and may be configured as a transmitting TM RLC entity or as a receiving TM RLC entity. In the UM, segmentation and/or concatenation of data received from a higher layer, addition of an RLC header, and the like may be performed, but retransmission control of data need not be performed. A UM RLC entity may be a uni-directional entity, or may be a bi-directional entity. In a case that the UM RLC entity is a uni-directional entity, the UM RLC entity may be configured as a transmitting UM RLC entity or as a receiving UM RLC entity. In a case that the UM RLC entity is a bi-directional entity, the UM RRC entity may be configured as a UM RLC entity including a transmitting side and a receiving side. In the AM, segmentation and/or concatenation of data received from a higher layer, addition of an RLC header, retransmission control of data, and the like may be performed. An AM RLC entity may be a bi-directional entity, and may be configured as an AM RLC including a transmitting side and a receiving side. Note that data provided to a lower layer and/or data provided from a lower layer in the TM may be referred to as a TMD PDU. Data provided to a lower layer and/or data provided from a lower layer in the UM may be referred to as a UMD PDU. Data provided to a lower layer or data provided from a lower layer in the AM may be referred to as an AMD PDU. An RLC PDU format used in the E-UTRA RLC and an RLC PDU format used in the NR RLC may be different from each other. The RLC PDU may include an RLC PDU for data and an RLC PDU for control. The RLC PDU for data may be referred to as an RLC DATA PDU (RLC Data PDU, RLC data PDU). The RLC PDU for control may be referred to as an RLC CONTROL PDU (RLC Control PDU, RLC control PDU). Note that the control RLC PDU used for transmission of the status report may be referred to as a status PDU (STATUSPDU).

Note that, in the sidelink, the TM may be used for the SBCCH, only the UM is used in groupcast transmission and broadcast transmission, and the UM and the AM can be used in unicast transmission. In the sidelink, the UM in groupcast transmission and broadcast transmission supports only unidirectional transmission.

An example of the functions of the PDCP will be described. The PDCP may be referred to as a PDCP sublayer. The PDCP may have a function of maintenance of the sequence number. The PDCP may have a header compression and decompression function for efficiently transmitting, in wireless sections, user data such as an IP Packet and an Ethernet frame. A protocol used for header compression and decompression for an IP packet may be referred to as a Robust Header Compression (ROHC) protocol. A protocol used for header compression and decompression for an Ethernet frame may be referred to as an Ethernet (trade name) Header Compression (EHC) protocol. The PDCP may have a function of encrypting and decrypting data. The PDCP may have a function of data integrity protection and integrity verification. The PDCP may have a function of re-ordering. The PDCP may have a function of retransmitting the PDCP SDU. The PDCP may have a function of discarding data using a discard timer. The PDCP may have a Duplication function. The PDCP may have a function of discarding pieces of data received in a duplicate manner. The PDCP entity may be a bi-directional entity, and may include a transmitting PDCP entity and a receiving PDCP entity. A PDCP PDU format used in the E-UTRA PDCP and a PDCP PDU format used in the NR PDCP may be different from each other. The PDCP PDU may include a PDCP PDU for data and a PDCP PDU for control. The PDCP PDU for data may be referred to as a PDCP DATA PDU (PDCP Data PDU, PDCP data PDU). The PDCP PDU for control may be referred to as a PDCP CONTROL PDU (PDCP Control PDU, PDCP control PDU).

Note that, in the sidelink, there are the following restrictions on the functions and services of the PDCP.
(1) Out-of-order delivery may be supported exclusively in unicast transmission.
(2) Duplication on the PC5 interface is not supported.

An example of the functions of the SDAP will be described. The SDAP is a service data adaptation protocol layer. In the sidelink, the SDAP may have a function of performing mapping between sidelink QoS flows (PC5 QoS flow) and sidelink data radio bearers (SL-DRBs), which are sent from the terminal apparatus to another terminal apparatus. The SDAP may have a function of storing mapping rule information. The SDAP may have a function of performing marking of a QoS flow identifier (QoS Flow ID (QFI)) and a PC5 QoS flow identifier (PC5 QoS Flow ID: PQFI or PFI). Note that the SDAP PDU may include an SDAP PDU for data and an SDAP PDU for control. The SDAP PDU for data may be referred to as an SDAP DATA PDU (SDAP Data PDU, SDAP data PDU). The SDAP PDU for control may be referred to as an SDAP CONTROL PDU (SDAP Control PDU, SDAP control PDU). Note that, in the sidelink, there may be one SDAP entity of the terminal apparatus per destination for any one of unicast transmission, groupcast transmission, and broadcast transmission associated with the destination. Reflective QoS is not supported on the PC5 interface.

An example of the functions of the RRC will be described. RRC may support services and functions on the PC5 interface such as forwarding of PC5-RRC messages between peer UEs, maintenance and release of the PC5-RRC connection between two UEs, and detection of a failure in sidelink radio link for PC5-RRC connection. The PC5-RRC connection is considered to be a logical connection between two UEs corresponding to a pair of a source L2ID and a destination L2ID and to be established after a corresponding PC5 unicast link is established. There is a one-to-one correspondence between the PC5-RRC connection and the PC5 unicast link. The UE may have multiple PC5-RRC connections to one or multiple UEs for different pairs of source L2IDs and destination L2IDs. A separate PC5-RRC procedure and separate messages may be used for the UE to transfer UE capabilities and sidelink configurations to peer UE. Both peer UEs may exchange the UE capabilities and sidelink configurations thereof with each other using a separate bi-directional procedure. In a case of being uninterested in the sidelink transmission, the UE releases the PC5-RRC connection in a case that a failure in sidelink radio link for the PC5-RRC connection is detected and that the Layer-2 link release procedure is completed.

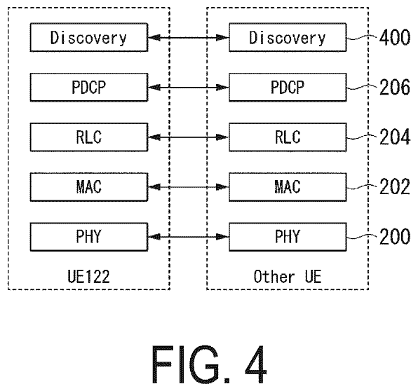

A terminal apparatus capable of sidelink communication may perform discovery. Discovery may include Model A and Model B. FIG. 4 illustrates a protocol stack used in a discovery procedure. Mode A may use a single discovery protocol message and Model B may use two discovery protocol messages. The single discovery protocol message in Model A may be an Announcement message, and the discovery protocol message in Model B may include a Solicitation message and a Response message. Note that the announcement message, the solicitation message, and the response message may be collectively referred to as a discovery message, and a message having another name and used in the discovery procedure may be referred to as a discovery message. The outline of a procedure for Model A and Model B in ProSe Direct Discovery will be described below.

In Model A, a UE that transmits an announcement message may be referred to as an Announcing UE, and a UE that monitors the announcement message may be referred to as a Monitoring UE. The announcement message may include information such as a discovery message type, a ProSe Application Code or a ProSe Restricted Code, a security protection element, and may additionally include metadata information. The announcement message is transmitted using a Destination Layer-2 ID (destination L2ID) and a Source Layer-2 ID (source L2ID), and the monitoring UE determines the destination L2ID to receive the announcement message. Note that the destination L2ID may be a Layer-2 identifier of the destination UE, and the source L2ID may be a Layer-2 identifier of the source UE. The destination UE may be simply referred to as a destination.

In Model B, a UE transmitting a solicitation message may be referred to as a discoverer UE, and a UE receiving the solicitation message and/or a UE transmitting a response message to the discoverer UE may be referred to as a discoveree UE. The solicitation message may include information such as a type of the discovery message, a ProSe Query Code, and a security protection element. The solicitation message is transmitted using the destination L2ID and the source L2ID, and the discoveree UE determines the destination L2ID to receive the solicitation message. The discoveree UE responding to the solicitation message transmits the response message. The response message may include information such as the discovery message type, a ProSe Response Code, and the security protection element, and may additionally include metadata information. The response message is transmitted using the source L2ID, and the destination L2ID is set to the source L2ID of the received solicitation message.

Discovery may include types other than ProSe Direct Discovery in which another UE is discovered in order to perform direct communication with the other UE, and may include Group member Discovery in which one or multiple UEs are discovered in order to perform communication within a group using a sidelink, 5G ProSe UE-to-Network Relay Discovery in which candidate relay UEs are discovered in order to connect to the network via a relay UE, and the like. Although the above-described discovery is an example of discovery provided by an application called ProSe, in addition to the above-described type, different types of discovery may be present according to an application or service for sidelink communication. Information included in the discovery protocol message may vary according to the type of discovery, and an additional message may be transmitted to transmit additional information.

FIG. 4 is a diagram of an example of a protocol structure including the discovery protocol according to the present embodiment. As illustrated in FIG. 4, a protocol stack of a discovery plane including the discovery protocol may include the Physical layer (PHY) 200 which is a radio physical layer, the Medium Access Control (MAC) 202 which is a medium access control layer, the Radio Link Control (RLC) 204 which is a radio link control layer, a Packet Data Convergence Protocol (PDCP) 206 which is a packet data convergence protocol layer, and Discovery 400 which is a discovery protocol layer. The Discovery 400 may be a protocol used to handle procedures related to discovery. An interface between UEs performing discovery may be referred to as PC5-D.

Multiple resource pools may be configured for transmitting a message used in a procedure related to discovery (discovery message), and one or multiple resource pools may be configured as dedicated resource pools for discovery. In a case that a dedicated resource pool for discovery is configured, the UE may use the dedicated resource pool for discovery as a resource pool for transmitting the discovery message, and in a case that no dedicated resource pool for discovery is configured, the UE may use the resource pool for sidelink communication as the resource pool for transmitting the discovery message. Note that multiple resource pools for sidelink communication may be configured together with multiple dedicated resource pools for discovery. Each resource pool may be configured by dedicated signalling for UE or may be preconfigured.

In each unicast PC5-RRC connection, a signaling radio bearer (SRB) for the sidelink may be configured. The SRB for the sidelink used to transmit the PC5-S message before the PC5-S security is established may be referred to as an SL-SRB0. The SRB for the sidelink used to transmit the PC5-S message for establishing the PC5-S security may be referred to as an SL-SRB1. The SRB for the sidelink used to transmit a protected PCSS message after the PC5-S security is established may be referred to as an SL-SRB2. The SRB for the sidelink used to transmit protected PC5-RRC signalling after the PC5-S security is established may be referred to as an SL-SRB3. The SRB for the sidelink used to transmit and/or receive the discovery message in the NR may be referred to as an SL-SRB4. Note that the PC5-RRC signalling may be RRC signalling between UEs transmitted and/or received on the PC5. Note that the PC5-RRC signalling may be referred to as a PC5-RRC message or the like.

Multi-path relay (or Multi-path relaying) will be described. Multi-path relay may be a technology in which a terminal apparatus communicates with a base station apparatus using two paths, a direct path and an indirect path. The direct path may be a path through which the terminal apparatus directly communicates with the base station apparatus via the Uu interface. The indirect path may be a path through which the terminal apparatus communicates with the base station apparatus via the relay terminal apparatus. The interface between the terminal apparatus and the relay terminal apparatus may be a PC5 interface or a different interface. The relay terminal apparatus may be a terminal apparatus acting as a U2N Relay UE.

In the multi-path relay, a bearer mapped to a direct path may be referred to as a direct bearer, a bearer mapped to an indirect path may be referred to as an indirect bearer, and a bearer mapped to both the direct path and the indirect path may be referred to as a multi-path split bearer (MP (Multi-path) split bearer) or simply a split bearer.

In the multi-path split bearer, an RLC channel for the Uu interface and an RLC channel for the indirect path may be configured for the PDCP entity of the terminal apparatus with two paths of the direct path and the indirect path. In a case that the interface between the terminal apparatus and the relay terminal apparatus in the indirect path is a PC5 interface, the RLC channel for the indirect path may be an RLC channel for the PC5 interface. In a case that PDCP duplication is configured for the multi-path split bearer and the PDCP duplication is activated, the PDCP entity may duplicate the PDCP DATA PDU to be submitted to the lower layer and submit data to both of the multiple RLC channels configured for the PDCP entity. The multi-path split bearer may be referred to as a bearer configured with the multi-path split bearer. The multi-path split bearer may be configured for both the data radio bearer and the signaling radio bearer. In a case that the PDCP duplication is not configured (or the PDCP duplication is configured but is not activated) and a prioritized path is configured for a bearer to be configured with the split bearer, the PDCP DATA PDU may be submitted to a primary RLC entity configured for the prioritized path, and in a case that a split secondary RLC entity is configured and the amount of data to be submitted to the primary RLC entity and the split secondary RLC entity is equal to or greater than the threshold, the PDCP DATA PDU may be submitted to either the primary RLC entity or the split secondary RLC entity.

Here, a UE-to-Network (U2N) relay used in communication in the indirect path will be described. The U2N relay may be a function of providing connectivity to a network for a remote terminal apparatus (Remote UE). The remote terminal apparatus that connects to the network by using the U2N relay may be referred to as a U2N Remote UE. The terminal apparatus that provides the U2N Remote UE with connectivity to the network may be referred to as a U2N relay terminal apparatus (Relay UE) or simply a relay terminal apparatus (Relay UE). The U2N Relay UE may use the Uu interface for communication with the base station apparatus, or may use the PC5 interface for communication with the U2N Remote UE. The U2N relay may include a layer 2 (L2) U2N relay, a layer 3 (L3) U2N relay, and the like. A remote terminal apparatus in the L2 U2N relay may be specifically referred to as L2 U2N Remote UE, and a relay terminal apparatus in the L2 U2N relay may be specifically referred to as L2 U2N Relay UE. In the L2 U2N relay, there may be an SRAP (SRAP layer) 600, which is a Sidelink Relay Adaptation Protocol (SRAP) layer. Note that the SRAP 600 may be simply expressed as SRAP.

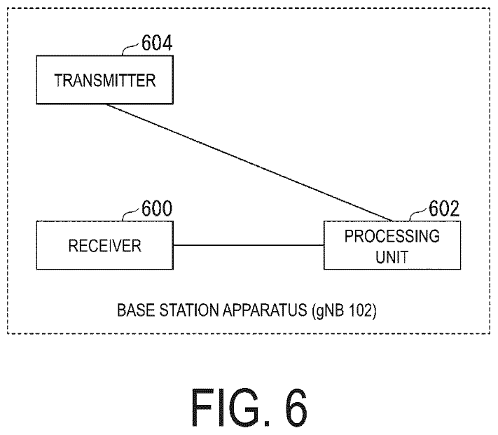

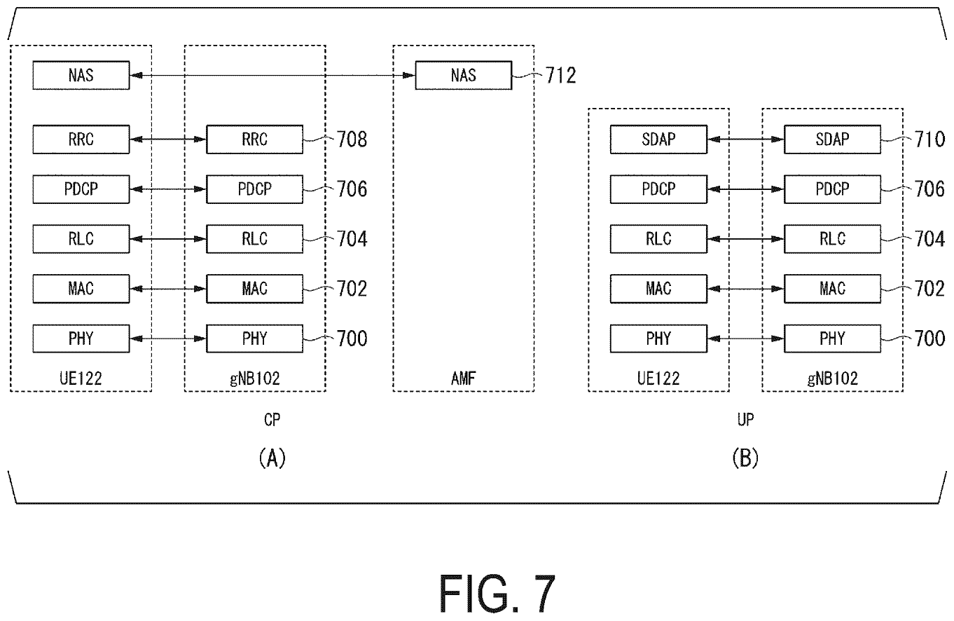

FIG. 6 is a diagram of an example of a protocol structure of the control plane (C-plane) including the SRAP layer according to the present embodiment. FIG. 7 is a diagram of an example of a protocol structure of the user plane (U-plane) including the SRAP layer according to the present embodiment. As illustrated in FIG. 6 and FIG. 7, the SRAP layer may be associated between the Remote UE and the RelayUE, and may also be associated between the Relay UE and the gNB 102. The gNB 102 illustrated in FIGS. 6 and 7 may be ng-eNB 100. The Remote UE or the Relay UE may be a UE 122.

Here, the SRAP layer will be described. The SRAP layer may be referred to as an SRAP sublayer, or simply SRAP. The SRAP sublayer may reside above the RLC sublayer for the control plane and user plane of both the PC5 and Uu interfaces. The SRAP sublayer on the PC5 may be used for the purpose of bearer mapping. In the L2 U2N Relay UE, the SRAP sublayer includes one SRAP entity on the Uu interface, and may include a separate collocated SRAP entity on the PC5 interface. In the L2 U2N Remote UE, the SRAP sublayer may include only one SRAP entity on the PC5 interface. The SRAP entity associated between the Remote UE and the Relay UE via the PC5 interface may be specifically referred to as a PC5-SRAP, and the SRAP entity associated between the Relay UE and the gNB via the Uu may be specifically referred to as a Uu-SRAP. In a case that an interface name is clarified, other entities may be expressed in a format such as (interface name)−(entity name), similarly to the SRAP. Each SRAP entity may include a transmitter and a receiver. On the PC5 interface, the transmitter of the SRAP entity of the L2 U2N Remote UE may be associated with the receiver of the SRAP entity of the L2 U2N Relay UE, and the receiver of the SRAP entity of the L2 U2N Remote UE may be associated with the transmitter of the SRAP entity of the L2 U2NRelay UE. On the Uu interface, the transmitter of the SRAP entity of the L2 U2N Relay UE may be associated with the receiver of the SRAP entity of gNB 102, and the receiver of the SRAP entity of the L2 U2N Relay UE may be associated with the transmitter of the SRAP entity of gNB 102.

The SRAP entity may have a function of transferring data, a function of determining a UE ID field and a bearer ID field of an SRAP header to be added to a data packet, a function of determining an egress link, and a function of determining an egress RLC channel.

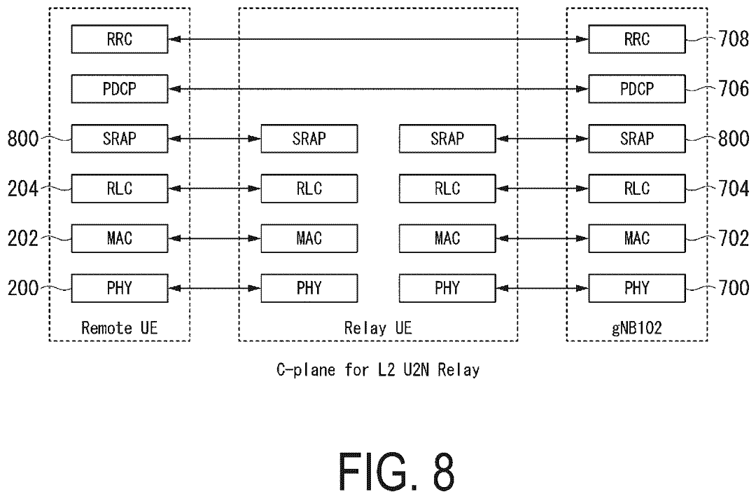

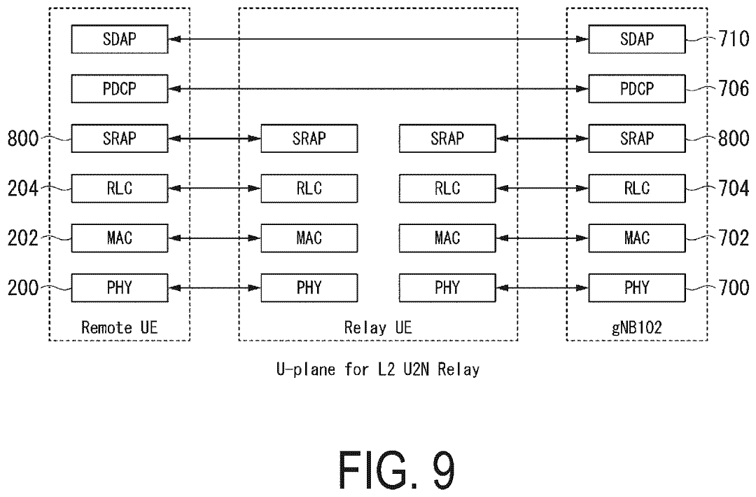

In FIGS. 8 and 9, a PC5 Relay RLC channel may be configured between the Remote UE and the Relay UE, and a Uu Relay RLC channel may be configured between the Relay UE and the gNB 102.

Next, a protocol structure used between the base station apparatus and the terminal apparatus will be described. In communication performed on the Uu interface between the terminal apparatus and the base station apparatus, that is, communication in the direct path, communication performed via the relay terminal apparatus configured in the indirect path, and communication performed on the Uu interface between the relay terminal apparatus and the base station apparatus, a protocol used between the base station apparatus and the terminal apparatus may be used. Note that, in communication performed between the remote terminal apparatus and the base station apparatus via the relay terminal apparatus, some protocols need not be associated between the remote terminal apparatus and the base station apparatus.

FIG. 7 is a diagram of an example of an NR protocol structure according to the present embodiment. Functions of each protocol to be described with reference to FIG. 7 are a part of functions closely related to the present embodiment, and other functions may be provided. Note that, in the present embodiment, an uplink (UL) may be a link from the terminal apparatus to the base station apparatus. In the present embodiment, a downlink (DL) may be a link from the base station apparatus to the terminal apparatus.

FIG. 7(A) is a diagram of an NR control plane (CP) protocol stack. As illustrated in FIG. 7(A), the NR CP protocol may be a protocol between the UE 122 and the gNB 102. In other words, the NR CP protocol may be a protocol terminated in the gNB 102 on a network side. As illustrated in FIG. 7(A), the NR control plane protocol stack may include a Physical layer (PHY) 700 which is a radio physical layer, a Medium Access Control (MAC) 702 which is a medium access control layer, an RLC 704 which is a radio link control layer, and a Packet Data Convergence Protocol (PDCP) 706 which is a packet data convergence protocol layer, and a Radio Resource Control (RRC) 708 which is a radio resource control layer. FIG. 7(B) is a diagram of an NR user plane (UP) protocol stack. As illustrated in FIG. 7(B), the NR UP protocol may be a protocol between the UE 122 and the gNB 102. In other words, the NR UP protocol may be a protocol terminated in the gNB 102 on the network side. As illustrated in FIG. 7(B), the NR user plane protocol stack may include a PHY 700 which is a radio physical layer, a MAC 702 which is a medium access control layer, an RLC 704 which is a radio link control layer, a PDCP 706 which is a packet data convergence protocol layer, and a Service Data Adaptation Protocol (SDAP) 710 which is a service data adaptation protocol layer.

Note that the Access Stratum (AS) layer may be a layer terminated between the UE 122 and the gNB 102. In other words, the AS layer may be a layer including a part or all of the PHY 700, the MAC 702, the RLC 704, the PDCP 706, and the RRC 708. The gNB 102 may also be ng-eNB 100. Although only the NR protocol is illustrated, the E-UTRA protocol may be used. In the E-UTRA protocol, the SDAP 710 need not be present, and the E-UTRA protocol may have a function that is partially different from that of the NR protocol.

Note that, in the present embodiment, terms such as a PHY (PHY layer), a MAC (MAC layer), an RLC (RLC layer), a PDCP (PDCP layer), and an RRC (RRC layer) may hereinafter be used, without the protocol of E-UTRA and the protocol of NR being distinguished from each other. In this case, the PHY (PHY layer), the MAC (MAC layer), the RLC (RLC layer), the PDCP (PDCP layer), and the RRC (RRC layer) may be the PHY (PHY layer), the MAC (MAC layer), the RLC (RLC layer), the PDCP (PDCP layer), and the RRC (RRC layer) of the E-UTRA protocol, or may be the PHY (PHY layer), the MAC (MAC layer), the RLC (RLC layer), the PDCP (PDCP layer), and the RRC (RRC layer) of the NR protocol, respectively. The SDAP (SDAP layer) may be the SDAP (SDAP layer) of the NR protocol.

In the present embodiment, in a case that the protocol of E-UTRA and the protocol of NR are distinguished from each other, the PHY 500, the MAC 502, the RLC 504, the PDCP 506, and the RRC 508 may be hereinafter respectively referred to as the PHY for E-UTRA or the PHY for LTE, the MAC for E-UTRA or the MAC for LTE, the RLC for E-UTRA or the RLC for LTE, the PDCP for E-UTRA or the PDCP for LTE, and the RRC for E-UTRA or the RRC for LTE. The PHY 500, the MAC 502, the RLC 504, the PDCP 506, and the RRC 508 may respectively be referred to as an E-UTRA PHY or an LTE PHY, an E-UTRA MAC or an LTEMAC, an E-UTRA RLC or an LTE RLC, an E-UTRA PDCP or an LTE PDCP, an E-UTRA RRC or an LTE RRC, and the like. In a case that the protocol of E-UTRA and the protocol of NR are distinguished from each other, the PHY 500, the MAC 502, the RLC 504, the PDCP 506, and the RRC 508 may be referred to as a PHY for NR, a MAC for NR, an RLC for NR, an RLC for NR, and an RRC for NR, respectively. The PHY 500, the MAC 502, the RLC 504, the PDCP 506, and the RRC 508 may be referred to as an NR PHY, an NR MAC, an NR RLC, an NR PDCP, an NR RRC, and the like, respectively.

Entities in the AS layer of E-UTRA and/or NR will be described. An entity having a part or all of functions of the physical layer may be referred to as a PHY entity. An entity having a part or all of functions of the MAC layer may be referred to as a MAC entity. An entity having a part or all of functions of the RLC layer may be referred to as an RLC entity. An entity having a part or all of functions of the PDCP layer may be referred to as a PDCP entity. An entity having a part or all of functions of the SDAP layer may be referred to as an SDAP entity. An entity having a part or all of functions of the RRC layer may be referred to as an RRC entity. The PHY entity, the MAC entity, the RLC entity, the PDCP entity, the SDAP entity, and the RRC entity may respectively be replaced with a PHY, a MAC, an RLC, a PDCP, an SDAP, and an RRC.

Note that data provided from the MAC, the RLC, the PDCP, and the SDAP to a lower layer, and/or data provided to the MAC, the RLC, the PDCP, and the SDAP from a lower layer may be referred to as a MAC Protocol Data Unit (PDU), an RLC PDU, a PDCP PDU, and an SDAP PDU, respectively. Data provided to the MAC, the RLC, the PDCP, and the SDAP from a higher layer, and/or data provided from the MAC, the RLC, the PDCP, and the SDAP to an upper layer may be referred to as a MAC Service Data Unit (SDU), an RLC SDU, a PDCP SDU, and an SDAP SDU, respectively. A segmented RLC SDU may be referred to as an RLC SDU segment.

Here, the base station apparatus and the terminal apparatus exchange (transmit and/or receive) signals with each other in higher layers. The higher layer may be referred to as an upper layer, and may be paraphrased with each other. For example, the base station apparatus and the terminal apparatus may transmit and/or receive an RRC message (also referred to as RRC signalling) in the Radio Resource Control (RRC) layer. In a Medium Access Control (MAC) layer, the base station apparatus and the terminal apparatus may transmit and/or receive a MAC control element. Additionally, the RRC layer of the terminal apparatus acquires system information broadcast from the base station apparatus. In this regard, the RRC message, the system information, and/or the MAC control element are also referred to as higher layer signalling (higher layer signaling) or a higher layer parameter. Each of the parameters included in the higher layer signalling received by the terminal apparatus may be referred to as a higher layer parameter. For example, in the processing of the PHY layer, the higher layer means a higher layer as viewed from the PHY layer, and thus may mean one or multiple of the MAC layer, the RRC layer, an RLC layer, a PDCP layer, a Non Access Stratum (NAS) layer, and the like. For example, in the processing of the MAC layer, the higher layer may mean one or multiple of the RRC layer, the RLC layer, the PDCP layer, the NAS layer, and the like.

Hereinafter, “A is given (provided) in the higher layer” or “A is given (provided) by the higher layer” may mean that the higher layer (mainly the RRC layer, the MAC layer, or the like) of the terminal apparatus receives A from the base station apparatus, and that the received A is given (provided) from the higher layer of the terminal apparatus to the physical layer of the terminal apparatus. For example, “a higher layer parameter being provided” in the terminal apparatus may mean that higher layer signalling is received from the base station apparatus, and a higher layer parameter included in the received higher layer signalling is provided from the higher layer of the terminal apparatus to the physical layer of the terminal apparatus. A higher layer parameter being configured for the terminal apparatus may mean that the higher layer parameter is given (provided) to the terminal apparatus. For example, a higher layer parameter being configured for the terminal apparatus may mean that the terminal apparatus receives higher layer signalling from the base station apparatus and configures the received higher layer parameter in the higher layer. However, a higher layer parameter being configured for the terminal apparatus may include a default parameter given in advance being configured in the higher layer of the terminal apparatus. In description of transmission of an RRC message from the terminal apparatus to the base station apparatus, the expression that a message is submitted from the RRC entity of the terminal apparatus to a lower layer may be used. In the terminal apparatus, “submitting a message to a lower layer” from the RRC entity may mean submitting a message to the PDCP layer. In the terminal apparatus, “submitting a message to a lower layer” from the RRC layer may mean submitting the message of the RRC to a PDCP entity corresponding to each SRB (SRB0, SRB1, SRB2, SRB3, or the like) because the message is transmitted using the SRB. In a case that the RRC entity of the terminal apparatus receives an indication from the lower layer, the lower layer may mean one or multiple of the PHY layer, the MAC layer, the RLC layer, the PDCP layer, and the like.

An example of the functions of the PHY will be described. The PHY of the terminal apparatus may have a function of receiving data transmitted from the PHY of the base station apparatus via a Downlink (DL) Physical Channel. The PHY of the terminal apparatus may have a function of transmitting data to the PHY of the base station apparatus via an Uplink (UL) physical channel. The PHY may be connected to an upper MAC with a Transport Channel. The PHY may deliver data to the MAC via the transport channel. The PHY may be provided with data from the MAC via the transport channel. In the PHY, in order to identify various pieces of control information, a Radio Network Temporary Identifier (RNTI) may be used.

Now, the physical channels will be described. The physical channels used for radio communication between the terminal apparatus and the base station apparatus may include the following physical channels.
Physical Broadcast CHannel (PBCH)
Physical Downlink Control CHannel (PDCCH)
Physical Downlink Shared CHannel (PDSCH)
Physical Uplink Control CHannel (PUCCH)
Physical Uplink Shared CHannel (PUSCH)
Physical Random Access CHannel (PRACH)

The PBCH may be used to broadcast system information required by the terminal apparatus.

The PBCH may be used to broadcast time indexes (SSB-Indexes) within the periodicity of Synchronization Signal Blocks (SSBs) in NR.

The PDCCH may be used to transmit (or carry) Downlink Control Information (DCI) in downlink radio communication (radio communication from the base station apparatus to the terminal apparatus). Here, one or multiple pieces of DCI (which may be referred to as DCI formats) may be defined for transmission of the downlink control information. In other words, a field for the downlink control information may be defined as DCI and may be mapped to information bits. The PDCCH may be transmitted in PDCCH candidates. The terminal apparatus may monitor a set of PDCCH candidates in a serving cell. To monitor a set of PDCCH candidates may mean an attempt to decode the PDCCH in accordance with a certain DCI format. The terminal apparatus may monitor the PDCCH candidates in monitoring occasions configured in one or multiple configured Control Resource Sets (CORESETs) configured by the search space configuration. The DCI format may be used for scheduling of the PUSCH in the serving cell. The PUSCH may be used for transmission of user data, transmission of RRC messages to be described below, and the like.

PDCCH repetition may be operated by using two search space sets explicitly linked by a configuration provided by the higher layer (RRC layer). The two linked search space sets may be associated with a corresponding CORESET. For PDCCH repetition, two linked search space sets may be configured for the terminal apparatus together with the same number of PDCCH candidates. Two PDCCH candidates present in the two linked search space sets may be linked by the same candidate index. In a case that PDCCH repetitions are scheduled for a terminal apparatus, inter-slot repetition may be allowed, and each repetition may have the same number of Control Channel Elements (CCEs) and coded bits (codedbits), and the same DCI payload.

The PUCCH is used to transmit Uplink Control Information (UCI) in a case of uplink radio communication (radio communication from the terminal apparatus to the base station apparatus). Here, the uplink control information may include Channel State Information (CSI) used to indicate a downlink channel state. The uplink control information may include a Scheduling Request (SR) used for requesting Uplink Shared CHannel (UL-SCH) resources. The uplink control information may include a Hybrid Automatic Repeat reQuest ACKnowledgement (HARQ-ACK).

The PDSCH may be used to transmit downlink data (Downlink Shared CHannel (DL-SCH)) from the MAC layer. In a case of the downlink, the PDSCH may be used to transmit System Information (SI), a Random Access Response (RAR), and the like.

The PUSCH may be used to transmit uplink data (Uplink-Shared CHannel (UL-SCH)) from the MAC layer or to transmit the HARQ-ACK and/or CSI along with the uplink data. The PUSCH may be used to transmit CSI only or a HARQ-ACK and CSI only. In other words, the PUSCH may be used to transmit the UCI only. The PDSCH or the PUSCH may be used to transmit an RRC message and a MAC CE described below. In this regard, in the PDSCH, the RRC message transmitted from the base station apparatus may be signalling common to multiple terminal apparatuses in a cell. The RRC message transmitted from the base station apparatus may be dedicated signalling (dedicated signaling) for a certain terminal apparatus. In other words, terminal apparatus-specific (UE-specific) information may be transmitted through dedicated signalling to the certain terminal apparatus. Additionally, the PUSCH may be used to transmit UE capabilities in the uplink.

The PRACH may be used for transmitting a random access preamble. The PRACH may be used to indicate an initial connection establishment procedure, a handover procedure, a connection reestablishment (connection re-establishment) procedure, synchronization (timing adjustment) for uplink transmission, and a request for a UL-SCH resource.

An example of the functions of the MAC will be described. The MAC may be referred to as a MAC sublayer. The MAC may have a function of mapping various Logical Channels to their corresponding transport channels. The logical channel may be identified with a Logical Channel Identity (or Logical Channel ID). The MAC may be connected to an upper RLC with a logical channel. The logical channel may be classified into a control channel for transmitting control information and a traffic channel for transmitting user information depending on the type of information to be transmitted. The logical channel may be classified into an uplink logical channel and a downlink logical channel. The MAC may have a function of multiplexing MAC SDUs belonging to one or multiple different logical channels and providing the multiplexed MAC SDUs to the PHY. The MAC may have a function of demultiplexing the MAC PDUs provided from the PHY and providing the demultiplexed MAC PDUs to a higher layer via the logical channels to which the respective MAC SDUs belong. The MAC may have a function of performing error correction through a Hybrid Automatic Repeat reQuest (HARQ). The MAC may have a function of reporting scheduling information. The MAC may have a function of performing priority processing among the terminal apparatuses by using dynamic scheduling. The MAC may have a function of performing priority processing among the logical channels in one terminal apparatus. The MAC may have a function of performing priority processing of resources overlapping in one terminal apparatus. The E-UTRA MAC may have a function of identifying Multimedia Broadcast Multicast Services (MBMS). The NR MAC may have a function of identifying a Multicast Broadcast Service (MBS). The MAC may have a function of selecting a transport format. The MAC may have a function of performing Discontinuous Reception (DRX) and/or Discontinuous Transmission (DTX), a function of performing a Random Access (RA) procedure, a Power Headroom Report (PHR) function of indicating information of transmittable power, a Buffer Status Report (BSR) function of indicating data volume information of a transmission buffer, and the like. The NR MAC may have a Bandwidth Adaptation (BA) function. A MAC PDU format used in the E-UTRA MAC and a MAC PDU format used in the NR MAC may be different from each other. The MAC PDU may include a MAC control element (MAC CE) being an element for performing control in the MAC.

Uplink (UL) and/or Downlink (DL) logical channels used in E-UTRA and/or NR will be described.

A Broadcast Control Channel (BCCH) may be a downlink logical channel for broadcasting control information, such as System Information (SI).

A Paging Control Channel (PCCH) may be a downlink logical channel for carrying a Paging message.

A Common Control Channel (CCCH) may be a logical channel for transmitting control information between the terminal apparatus and the base station apparatus. The CCCH may be used in a case that the terminal apparatus does not have RRC connection. The CCCH may be used between the base station apparatus and multiple terminal apparatuses.

A Dedicated Control Channel (DCCH) may be a logical channel for transmitting dedicated control information in a point-to-point bi-directional manner between the terminal apparatus and the base station apparatus. The dedicated control information may be control information dedicated to each terminal apparatus. The DCCH may be used in a case that the terminal apparatus has RRC connection.

A Dedicated Traffic Channel (DTCH) may be a logical channel for transmitting user data in a point-to-point manner between the terminal apparatus and the base station apparatus. The DTCH may be a logical channel for transmitting dedicated user data. The dedicated user data may be user data dedicated to each terminal apparatus. The DTCH may be present in both of the uplink and the downlink.

Mapping between the logical channels and the transport channels in uplink, in E-UTRA and/or NR will be described.

The CCCH may be mapped to an Uplink Shared Channel (UL-SCH) being an uplink transport channel.

The DCCH may be mapped to an Uplink Shared Channel (UL-SCH) being an uplink transport channel.

The DTCH may be mapped to an Uplink Shared Channel (UL-SCH) being an uplink transport channel.

Mapping between the logical channels and the transport channels in downlink, in E-UTRA and/or NR will be described.

The BCCH may be mapped to a Broadcast Channel (BCH) and/or a Downlink Shared Channel (DL-SCH) being a downlink transport channel.

The PCCH may be mapped to a Paging Channel (PCH) being a downlink transport channel.

The CCCH may be mapped to a Downlink Shared Channel (DL-SCH) being a downlink transport channel.

The DCCH may be mapped to a Downlink Shared Channel (DL-SCH) being a downlink transport channel.

The DTCH may be mapped to a Downlink Shared Channel (DL-SCH) being a downlink transport channel.

An example of the functions of the RLC will be described. The RLC may be referred to as an RLC sublayer. The E-UTRA RLC may have a function of segmenting (Segmentation) and/or concatenating (Concatenation) data provided from the PDCP of a higher layer, and providing the segmented and/or concatenated data to a lower layer. The E-UTRA RLC may have a function of reassembling (reassembly) and re-ordering data provided from a lower layer, and providing the reassembled and re-ordered data to a higher layer. The NR RLC may have a function of assigning data provided from the PDCP of a higher layer with a sequence number independent of a sequence number assigned in the PDCP. The NR RLC may have a function of segmenting (Segmentation) data provided from the PDCP and providing the segmented data to a lower layer. The NR RLC may have a function of reassembling (reassembly) data provided from a lower layer, and providing the reassembled data to a higher layer. The RLC may have a data retransmission function and/or retransmission request function (AutomaticRepeat reQuest (ARQ)). The RLC may have a function of performing error correction using the ARQ. Control information that indicates data required to be retransmitted and that is transmitted from a receiving side to a transmitting side of the RLC in order to perform the ARQ may be referred to as a status report. A status report transmission indication transmitted from the transmitting side to the receiving side of the RLC may be referred to as a poll. The RLC may have a function of detecting data duplication. The RLC may have a function of discarding data. The RLC may have three modes, namely a Transparent Mode (TM), an Unacknowledged Mode (UM), and an Acknowledged Mode (AM). In the TM, segmentation of data received from a higher layer may not be performed, and addition of an RLC header need not be performed. A TM RLC entity may be a uni-directional entity, and may be configured as a transmitting TM RLC entity or as a receiving TM RLC entity. In the UM, segmentation and/or concatenation of data received from a higher layer, addition of an RLC header, and the like may be performed, but retransmission control of data need not be performed. A UM RLC entity may be a uni-directional entity, or may be a bi-directional entity. In a case that the UM RLC entity is a uni-directional entity, the UM RLC entity may be configured as a transmitting UM RLC entity or as a receiving UM RLC entity. In a case that the UM RLC entity is a bi-directional entity, the UM RRC entity may be configured as a UM RLC entity including a transmitting side and a receiving side. In the AM, segmentation and/or concatenation of data received from a higher layer, addition of an RLC header, retransmission control of data, and the like may be performed. An AM RLC entity may be a bi-directional entity, and may be configured as an AM RLC including a transmitting side and a receiving side. Note that data provided to a lower layer and/or data provided from a lower layer in the TM may be referred to as a TMD PDU. Data provided to a lower layer and/or data provided from a lower layer in the UM may be referred to as a UMD PDU. Data provided to a lower layer or data provided from a lower layer in the AM may be referred to as an AMD PDU. An RLC PDU format used in the E-UTRA RLC and an RLC PDU format used in the NR RLC may be different from each other. The RLC PDU may include an RLC PDU for data and an RLC PDU for control. The RLC PDU for data may be referred to as an RLC DATA PDU (RLC Data PDU, RLC data PDU). The RLC PDU for control may be referred to as an RLC CONTROL PDU (RLC Control PDU, RLC control PDU).

An example of the functions of the PDCP will be described. The PDCP may be referred to as a PDCP sublayer. The PDCP may have a function of maintenance of the sequence number. The PDCP may have a header compression and decompression function for efficiently transmitting, in wireless sections, user data such as an IP Packet and an Ethernet frame. A protocol used for header compression and decompression for an IP packet may be referred to as a Robust Header Compression (ROHC) protocol. A protocol used for header compression and decompression for an Ethernet frame may be referred to as an Ethernet (trade name) Header Compression (EHC) protocol. The PDCP may have a function of encrypting and decrypting data. The PDCP may have a function of data integrity protection and integrity verification. The PDCP may have a function of re-ordering. The PDCP may have a function of retransmitting the PDCP SDU. The PDCP may have a function of discarding data using a discard timer. The PDCP may have a Duplication function. The PDCP may have a function of discarding pieces of data received in a duplicate manner. The PDCP entity may be a bi-directional entity, and may include a transmitting PDCP entity and a receiving PDCP entity. A PDCP PDU format used in the E-UTRA PDCP and a PDCP PDU format used in the NR PDCP may be different from each other. The PDCP PDU may include a PDCP PDU for data and a PDCP PDU for control. The PDCP PDU for data may be referred to as a PDCP DATA PDU (PDCP Data PDU, PDCP data PDU). The PDCP PDU for control may be referred to as a PDCP CONTROL PDU (PDCP Control PDU, PDCP control PDU).

An example of the functions of the SDAP will be described. The SDAP is a service data adaptation protocol layer. The SDAP may have a function of performing association (mapping) between a downlink QoS flow transmitted from the 5GC to the terminal apparatus via the base station apparatus and a data radio bearer (DRB) and/or mapping between an uplink QoS flow transmitted from the terminal apparatus to the 5GC via the base station apparatus and a DRB. The SDAP may have a function of storing mapping rule information. The SDAP may have a function of performing marking of a QoS flow identifier (QoS Flow ID (QFI)). Note that the SDAP PDU may include an SDAP PDU for data and an SDAP PDU for control. The SDAP PDU for data may be referred to as an SDAP DATA PDU (SDAP Data PDU, SDAP data PDU). The SDAP PDU for control may be referred to as an SDAP CONTROL PDU (SDAP Control PDU, SDAP control PDU). Note that, in the terminal apparatus, one SDAP entity may be present for one PDU session.

An example of the functions of the RRC will be described. The RRC may have a broadcast function. The RRC may have a Paging function from the 5GC. The RRC may have a Paging function from the gNB 102 or the ng-eNB 100. The RRC may have an RRC connection management function. The RRC may have a radio bearer control function. The RRC may have a cell group control function. The RRC may have a mobility control function. The RRC may have a terminal apparatus measurement reporting and terminal apparatus measurement reporting control function. The RRC may have a QoS management function. The RRC may have a radio link failure detection and recovery function. The RRC may perform broadcasting, paging, RRC connection management, radio bearer control, cell group control, mobility control, terminal apparatus measurement reporting and terminal apparatus measurement reporting control, QoS management, detection and recovery of radio link failure, and the like by using the RRC message. Note that RRC messages and parameters used in the E-UTRA RRC may be different from RRC messages and parameters used in the NR RRC. Note that the RRC message may include multiple Information Elements (IEs) for performing the above-described control and the like.

The RRC message may be transmitted using the BCCH of the logical channel, may be transmitted using the PCCH of the logical channel, may be transmitted using the CCCH of the logical channel, or may be transmitted using the DCCH of the logical channel. The RRC message transmitted using the DCCH is referred to as dedicated RRC signalling (Dedicated RRC signaling) or RRC signalling.

In the RRC message transmitted using the BCCH, for example, a Master Information Block (MIB) may be included, a System Information Block (SIB) of each type may be included, or another RRC message may be included. In the RRC message transmitted using the PCCH, for example, a paging message may be included, or another RRC message may be included.

In the RRC message transmitted in the uplink (UL) direction using the CCCH, for example, an RRC setup request message (RRC Setup Request), an RRC resume request message (RRC Resume Request), an RRC reestablishment request message (RRC Reestablishment Request), an RRC system information request message (RRC System Info Request), and the like may be included. For example, an RRC connection request message (RRC Connection Request), an RRC connection resume request message (RRC Connection Resume Request), an RRC connection reestablishment request message (RRC Connection Reestablishment Request), and the like may be included. Another RRC message may be included.

In the RRC message transmitted in the downlink (DL) direction using the CCCH, for example, an RRC connection reject message (RRC Connection Reject), an RRC connection setup message (RRC Connection Setup), an RRC connection reestablishment message (RRC Connection Reestablishment), an RRC connection reestablishment reject message (RRC Connection Reestablishment Reject), and the like may be included. For example, an RRC reject message (RRC Reject), an RRC setup message (RRC Setup), and the like may be included. Another RRC message may be included.

In the RRC signalling transmitted in the uplink (UL) direction using the DCCH, for example, a measurement report message (Measurement Report), an RRC connection reconfiguration complete message (RRC Connection Reconfiguration Complete), an RRC connection setup complete message (RRC Connection Setup Complete), an RRC connection reestablishment complete message (RRC Connection Reestablishment Complete), a security mode complete message (Security Mode Complete), a UE capability information message (UE Capability Information), and the like may be included. For example, a measurement report message (Measurement Report), an RRC reconfiguration complete message (RRC Reconfiguration Complete), an RRC setup complete message (RRC Setup Complete), an RRC reestablishment complete message (RRC Reestablishment Complete), an RRC resume complete message (RRC Resume Complete), a security mode complete message (Security Mode Complete), a UE capability information message (UE Capability Information), and the like may be included. Another RRC signalling may be included.

In the RRC signalling transmitted in the downlink (DL) direction using the DCCH, for example, an RRC connection reconfiguration message (RRC Connection Reconfiguration), an RRC connection release message (RRC Connection Release), a security mode command message (Security Mode Command), a UE capability enquiry message (UE Capability Enquiry), and the like may be included. For example, an RRC reconfiguration message (RRC Reconfiguration), an RRC resume message (RRC Resume), an RRC release message (RRC Release), an RRC reestablishment message (RRC Reestablishment), a security mode command message (Security Mode Command), a UE capability enquiry message (UE Capability Enquiry), and the like may be included. Another RRC signalling may be included.

The functions of the PHY, the MAC, the RLC, the PDCP, the SDAP, and the RRC described above are merely an example, and a part or all of each of the functions need not be implemented. Some or all of the functions of each layer may be included in another layer.

The radio bearers will be described. In a case that the terminal apparatus communicates with the base station apparatus, radio connection may be performed by establishing a Radio Bearer (RB) between the terminal apparatus and the base station apparatus. The radio bearer used for the CP may be referred to as a signaling radio bearer (SRB). The radio bearer used for the UP may be referred to as a Data Radio Bearer (DRB). Each radio bearer may be assigned a radio bearer identity (Identity (ID)). The radio bearer identity for the SRB may be referred to as an SRB identity (or SRB ID). The radio bearer identity for the DRB may be referred to as a DRB identity (or DRB ID). For the SRBs of E-UTRA, SRB0 to SRB2 may be defined, or SRBs other than these may be defined. For the SRBs of NR, SRB0 to SRB3 may be defined, or SRBs other than these may be defined. SRB0 may be an SRB for an RRC message transmitted and/or received using the CCCH of the logical channel. SRB1 may be an SRB for RRC signalling, and for NAS signalling before establishment of SRB2. The RRC signalling transmitted and/or received using SRB1 may include a piggybacked NAS signalling. For all of RRC signalling and NAS signalling transmitted and/or received using SRB1, the DCCH of the logical channel may be used. SRB2 may be an SRB for NAS signalling, and for RRC signalling including logged measurement information. For all of RRC signalling and NAS signalling transmitted and/or received using SRB2, the DCCH of the logical channel may be used. SRB2 may have a lower priority than SRB1. SRB3 may be an SRB for transmitting and/or receiving specific RRC signalling in a case that EN-DC, NGEN-DC, NR-DC, or the like is configured for the terminal apparatus. For all of RRC signalling and NAS signalling transmitted and/or received using SRB3, the DCCH of the logical channel may be used. Other SRBs may also be provided for other applications. The DRB may be a radio bearer for user data. For RRC signalling transmitted and/or received using the DRB, the DTCH of the logical channel may be used.

The radio bearers in the terminal apparatus will be described. The radio bearers may include an RLC bearer. The RLC bearer may include one or two RLC entities and a logical channel. The RLC entities in a case that the RLC bearer includes two RLC entities may be the transmitting RLC entity and the receiving RLC entity in the TM RLC entity and/or the uni-directional UM mode RLC entity. SRB0 may include one RLC bearer. The RLC bearer of SRB0 may include the RLC entity of TM, and a logical channel. SRB0 may be constantly established in the terminal apparatus in all of the states (the RRC idle state, the RRC connected state, the RRC inactive state, and the like). In a case that the terminal apparatus transitions from the RRC idle state to the RRC connected state, one SRB1 may be established and/or configured for the terminal apparatus, using RRC signalling received from the base station apparatus. SRB1 may include one PDCP entity, and one or multiple RLC bearers. The RLC bearer of SRB1 may include the RLC entity of AM, and a logical channel. One SRB2 may be established and/or configured for the terminal apparatus, using RRC signalling that the terminal apparatus in the RRC connected state with activated AS security receives from the base station apparatus. SRB2 may include one PDCP entity, and one or multiple RLC bearers. The RLC bearer of SRB2 may include the RLC entity of AM and a logical channel. Note that the PDCP of SRB1 and SRB2 on the base station apparatus side may be deployed in the master node. In a case that the secondary node in EN-DC, NGEN-DC, or NR-DC is added or in a case that the secondary node is changed, one SRB3 may be established and/or configured for the terminal apparatus, using RRC signalling that the terminal apparatus in the RRC connected state with activated AS security receives from the base station apparatus. SRB3 may be a direct SRB between the terminal apparatus and the secondary node. SRB3 may include one PDCP entity, and one or multiple RLC bearers. The RLC bearer of SRB3 may include the RLC entity of AM, and a logical channel. The PDCP of the SRB3 on the base station apparatus side may be deployed in the secondary node. One or multiple DRBs may be established and/or configured for the terminal apparatus, using RRC signalling that the terminal apparatus in the RRC connected state with activated AS security receives from the base station apparatus. The DRB may include one PDCP entity, and one or multiple RLC bearers. The RLC bearer of the DRB may include the RLC entity of AM or UM, and a logical channel.

The RLC entity established and/or configured for the RLC bearer established and/or configured for the cell group configured in E-UTRA may be the E-UTRA RLC. The RLC entity established and/or configured for the RLC bearer established and/or configured for the cell group configured in NR may be the NR RLC. In a case that EN-DC is configured for the terminal apparatus, the PDCP entity established and/or configured for a Master Node (MN) terminated MCG bearer may be either the E-UTRA PDCP or the NR PDCP. In a case that EN-DC is configured for the terminal apparatus, the PDCP established and/or configured for the radio bearers of other bearer types, i.e., an MN terminated split bearer, the MN terminated SCG bearer, a Secondary Node (SN) terminated MCG bearer, an SN terminated split bearer, and an SN terminated SCG bearer, may be the NR PDCP. In a case that NGEN-DC, NE-DC, or NR-DC is configured for the terminal apparatus, the PDCP entity established and/or configured for the radio bearers of all of the bearer types may be the NR PDCP.

Note that, in NR, the DRB established and/or configured for the terminal apparatus may be associated with one PDU session. One SDAP entity may be established and/or configured for one PDU session in the terminal apparatus. The SDAP entity, the PDCP entity, the RLC entity, and the logical channel established and/or configured for the terminal apparatus may be established and/or configured using RRC signalling that the terminal apparatus receives from the base station apparatus.

The Reference Signal Received Power (RSRP) measured in the sidelink may be, for example, the following RSRP. The following RSRP may be referred to as SL-RSRP.
(a) PSBCH RSRP
(b) PSSCH RSRP
(c) PSCCH RSRP

The PSBCH-RSRP (PSBCH RSRP) may be defined as a linear average of power contributions of resource elements carrying multiple Demodulation Reference Signals (DMRSs) associated with the PSBCH. The PSSCH-RSRP (PSSCH RSRP) may be defined as a linear average of power contributions of resource elements of antenna ports transmitting multiple DMRSs associated with the PSSCH, and in a case that there are multiple antenna ports, values of RSRP for each antenna port may be summed. The PSCCH-RSRP (PSCCH RSRP) may be defined as a linear average of power contributions of resource elements carrying multiple DMRS associated with the PSCCH. Note that the DMRS may be used to demodulate, for example, signals of the PSBCH, the PSSCH, and the PSCCH. The terminal apparatus that performs the sidelink communication with another terminal apparatus may measure the RSRP (SL-RSRP) of the sidelink communication by using the PSSCH or the PSCCH that is transmitted from the other terminal apparatus. The terminal apparatus may measure the RSRP (SD-RSRP) of the discovery message using the power contribution of a resource element that transmits the DMRS associated with the discovery message.

In the measurement in the sidelink, the UE 122 may measure the following quantities in addition to the SL-RSRP.
(a) Sidelink received signal strength indicator (SL RSSI)
(b) Sidelink channel Occupancy ratio (SL CR)
(c) Sidelink channel busy ratio (SL CBR)

The SL RSSI may be defined as a linear average of power ([W]) observed in configured subchannels within OFDM symbols of a slot configured for the PSCCH and the PSSCH, starting from a second OFDM symbol. The SL CR in slot n may be defined as a value obtained by dividing the sum of the number of subchannels used for sidelink transmission between slot [n −a] and slot [n −1] and the number of subchannels allocated between slot [n] and slot [n+b] by the sum of the number of subchannels configured between slot [n −a] and slot [n+b]. The SL CBR in slot n may be defined as a ratio of subchannels in which the SL RSSI exceeds a threshold in a resource pool in a period configured as a CBR measurement window (from slot [n−a] to slot [n −1]).

After the L2 U2N Remote UE discovers the candidate L2 U2N Relay UE and measures the RSRP of the candidate L2 U2N Relay UE, the L2 U2N Remote UE may report one or multiple candidate L2 U2N Relay UEs to the base station apparatus. Note that, before reporting one or multiple candidate L2 U2N Relay UEs to the base station apparatus, the L2 U2N Remote UE may determine whether the measured RSRP of the candidate L2 U2N Relay UE satisfies the selection criterion of the L2 U2N relay. The L2 U2N Remote UE may report, to the base station apparatus, only the candidate L2 U2N Relay UE that satisfies the selection criterion and matches a criterion of a higher layer. In a case of reporting one or multiple candidate L2 U2N Relay UEs to the base station apparatus, the L2 U2N Remote UE may include, in the report to the base station apparatus, the identification information of the candidate L2 U2N Relay UE, the identification information of the serving cell of the candidate L2 U2N Relay UE, and the measurement result. Note that the RSRP (SD-RSRP) of the discovery message transmitted by the candidate L2 U2NRelay UE may be used as the measurement result. Note that identification information may be an identifier (ID).

The L2 U2N Remote UE having the Serving L2 U2N Relay UE may use, for the measurement result, the RSRP (SL-RSRP) measured in the sidelink communication with the Serving L2 U2N Relay UE. Note that, in a case that the SL-RSRP cannot be used for the measurement result, the SD-RSRP may be used. Note that the serving L2 U2N Relay UE may be an L2 U2N Relay UE that provides an L2 U2N Remote UE with connectivity to the base station apparatus.

NR sidelink communication includes two resource allocation modes. Mode 1 refers to a mode in which the UE performs sidelink transmission by using a resource scheduled by the base station, and Mode 2 refers to a mode in which the UE automatically selects a resource to perform sidelink transmission. In Mode 1, the UE needs to be RRC_CONNECTED, and in Mode 2, the UE is capable of sidelink transmission regardless of the RRC state or whether the UE is inside or outside the NG-RAN. In Mode 2, the UE automatically selects a resource capable of sidelink transmission from one or multiple resource pools configured before sidelink transmission is performed.

Here, a bandwidth part (BWP) will be described.

The BWP may be a partial band or an entire band of the serving cell. The BWP may be referred to as a Carrier BWP. The terminal apparatus may be configured with one or multiple BWPs. A certain BWP may be configured by information included in system information associated with a synchronization signal detected in initial cell search. A certain BWP may be a frequency bandwidth associated with a frequency for performing the initial cell search. A certain BWP may be configured by RRC signalling (for example, Dedicated RRC signaling). A downlink BWP (DL BWP) and an uplink BWP (UL BWP) may be separately configured. One or multiple uplink BWPs may be associated with one or multiple downlink BWPs. Association between the uplink BWP and the downlink BWP may be prescribed association, may be association by RRC signalling (for example, Dedicated RRC signaling), may be association by physical layer signalling (for example, downlink control information (DCI) indicated on a downlink control channel, or may be a combination of those. A CORESET may be configured in the downlink BWP.

The BWP may include a group of continuous Physical Resource Blocks (PRBs). For the terminal apparatus in the connected state, parameters of the BWP(s) (one or multiple BWPs) of each component carrier may be configured. As parameters of the BWP of each component carrier, a part or all of the following: (A) a type of a cyclic prefix; (B) a subcarrier interval; (C) a frequency position of the BWP (for example, a start position or a center frequency position on a low frequency side of the BWP) (As the frequency position, for example, an ARFCN may be used, or an offset from a specific subcarrier of the serving cell may be used. The unit of the offset may be the subcarrier unit or the resource block unit. Both the ARFCN and the offset may be configured): (D) a bandwidth of the BWP (for example, the number of PRBs); (E) resource configuration information of the control signal; and (F) a center frequency position of an SS block (As the frequency position, for example, the ARFCN may be used, or the offset from a specific subcarrier of the serving cell may be used. The unit of the offset may be the subcarrier unit or the resource block unit. Both the ARFCN and the offset may be configured) may be included. The resource configuration information of a control signal may be included in at least configuration of a part or all of the BWPs of the PCell and/or the PSCell.

The terminal apparatus may perform transmission and/or reception in an Active BWP out of the one or multiple configured BWPs. In one serving cell associated with the terminal apparatus, one or multiple BWPs may be configured. Among the one or multiple BWPs configured for one serving cell associated with the terminal apparatus, at most one uplink BWP and/or at most one downlink BWP may be configured to function as an Active BWP at a certain time. The Active BWP of the downlink is also referred to as an Active DL BWP. The Active BWP of the uplink is also referred to as an Active UL BWP. Among one or multiple BWPs configured for the terminal apparatus, BWPs each being not an Active BWP may be referred to as Inactive BWPs.

Now, the Serving Cell will be described. In the terminal apparatus in the RRC connected state (RRC_CONNECTED) in which one serving cell is configured, the serving cell may include one Primary Cell (PCell). In the terminal apparatus in the RRC connected state in which multiple serving cells are configured, the serving cell may mean a set of multiple cells including one or multiple Special Cells (SpCells) and one or multiple all Secondary Cells (SCells). The SpCell may support PUCCH transmission and contention-based Random Access (CBRA). The PCell may be a cell used for an RRC connection establishment procedure in a case that the terminal apparatus in the RRC idle state (RRC_IDLE) transitions to the RRC connected state. The PCell may be a cell used for an RRC connection reestablishment procedure in which the terminal apparatus performs reestablishment of RRC connection. The PCell may be a cell used for a random access procedure in a case of a handover. The SpCell may be a cell used for purposes other than the purposes described above.

The group of serving cells configured for the terminal apparatus including the SpCell and one or more SCells may be considered as carrier aggregation (CA) being configured for the terminal apparatus. For the terminal apparatus configured with CA, a cell that provides additional radio resources to the SpCell may mean the SCell.

The Cell Group configured for the terminal apparatus from the base station apparatus will be described. The cell group may include one SpCell. The cell group may include one SpCell and one or multiple SCells. In other words, the cell group may include one SpCell, and optionally one or multiple SCells. The cell group may be expressed as a set of cells.

The UE 122 may receive a configuration of a special cell (SpCell) from the gNB 102. For example, the RRC reconfiguration (RRCReconfiguration) message may include a cell group configuration (an information element named CellGroupConfig), and the cell group configuration may include a special cell configuration (an information element named spCellConfig). An information element named spCellConfigDedicated included in the information element named spCellConfig may be an information element indicating a cell configuration dedicated to the UE 122 and configured in the SpCellConfig. The information element named spCellConfigDedicated may be replaced with an SpCellConfigDedicated or SpCell dedicated configuration. Note that the information element named spCellConfigDedicated may include a parameter of an identifier of a BWP named a first active downlink BWP identifier (firstActiveDownlinkBWP-Id) described later. The configuration of the special cell may include reconfiguration with synchronization (information element named reconfigurationWithSync). An information element named spCellConfigCommon included in the information element named reconfigurationWithSync may be used to configure a cell-specific parameter for the serving cell of the UE 122 (that is, the special cell). Note that, in order to clearly indicate that a certain word is an information element, the word may be expressed with a word “IE”. For example, the reconfiguration with synchronization IE may be included in an RRC reconfiguration message, and in a case of receiving the RRC reconfiguration message, the UE 122 may perform reconfiguration with synchronization (procedure) according to the RRC reconfiguration message.

Based on the above description, various examples of the present embodiment will be described. Note that the processing described above may be applied to processing not described in the following.

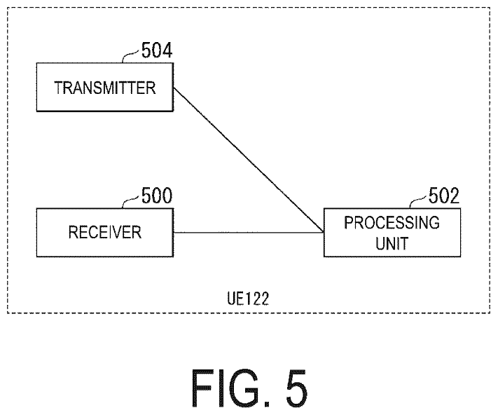

FIG. 5 is a block diagram illustrating a configuration of the terminal apparatus (UE 122) according to the present embodiment. Note that FIG. 5 illustrates only the main components closely related to the present embodiment in order to avoid complexity of description.

The UE 122 illustrated in FIG. 5 includes a receiver 500 that receives control information (SCI, MAC control elements, RRC signalling, and the like), information including the discovery message and user data, and the like from another terminal apparatus, a processing unit 502 that performs processing in accordance with parameters included in the received control information and the like, and a transmitter 504 that transmits control information (SCI, MAC control elements, RRC signalling, and the like), information including the discovery message and user data, and the like to another terminal apparatus. The receiver 500 may receive control information (MAC control elements, RRC signalling, etc.), information including user data, and the like from the base station apparatus (gNB 102). The transmitter 504 may transmit control information (MAC control elements, RRC signalling, etc.), information including user data, and the like to the base station apparatus (gNB 102). The processing unit 502 may include a part or all of functions of various layers (for example, the physical layer, the MAC layer, the RLC layer, the PDCP layer, the SDAP layer, the RRC layer, the PC5-S layer, the Discovery layer, and an application layer). That is, the processing unit 502 may include a part or all of a physical layer processing unit (PHY processing unit), a MAC layer processing unit (MAC processing unit), an RLC layer processing unit (RLC processing unit), a PDCP layer processing unit (PDCP processing unit), an SDAP processing unit, an RRC layer processing unit (RRC processing unit), a PC5-S layer processing unit (PC5-S processing unit), a Discovery layer processing unit (Discovery processing unit), and an application layer processing unit.

FIG. 6 is a block diagram illustrating a configuration of the base station apparatus (gNB 102) according to the present embodiment. Note that FIG. 6 illustrates only the main components closely related to the present embodiment in order to avoid complexity of description.

The base station apparatus illustrated in FIG. 6 includes a transmitter 604 that transmits control information (DCI, MAC CE, RRC signalling, and the like) to the UE 122, a processing unit 602 that creates control information (DCI, MAC CE, RRC signalling including parameters, and the like) and transmits the control information to the UE 122 to thereby cause the processing unit 502 of the UE 122 to perform processing, and a receiver 600 that receives control information (UCI, MAC CE, RRC signalling, and the like) from the UE 122. The processing unit 602 may include a part or all of functions of various layers (for example, the physical layer, the MAC layer, the RLC layer, the PDCP layer, the SDAP layer, the RRC layer, and the NAS layer). In other words, the processing unit 602 may include a part or all of a physical layer processing unit, a MAC layer processing unit, an RLC layer processing unit, a PDCP layer processing unit, an SDAP processing unit, an RRC layer processing unit, and a NAS layer processing unit.

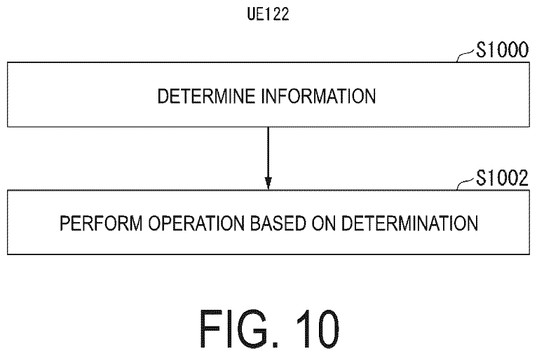

An example of the embodiment in one aspect of the present invention will be described with reference to FIG. 10.

In a case of receiving the RRC signalling from the base station apparatus, the UE 122 determines a condition in step S1000, and performs an operation based on the determination in step S1002.

In step S1000, the condition may be, for example, a part or all of the following conditions.
(s-a) the UE 122 is acting as a remote terminal apparatus.
(s-b) After the RRC signalling is applied, the UE 122 is configured with no direct path.

In the condition (s-a), the remote terminal apparatus may be an L2 U2N remote UE, or an L3 U2N remote UE, or a terminal apparatus that communicates with a base station apparatus via a relay node. The determining that the condition (s-a) is satisfied may be determining that a relay-related configuration used by a remote terminal apparatus is applied to the UE 122, and additionally or alternatively, may be determining that a relay-related configuration used by a remote terminal apparatus is applied to the UE 122 by the RRC signalling, and additionally or alternatively, may be determining that the SRAP layer has been configured by the base station apparatus, and additionally or alternatively, may be determining that the SRAP layer is configured by the RRC signalling. The condition (s-b) may be rephrased as addition of a direct path by the RRC signalling having not been performed, the UE being configured by the RRC signalling to communicate with the base station apparatus by using only an indirect path, and the like.

In a case that all of the conditions are determined to be satisfied, then in step S1002, the operation may be, for example, applying only the configuration that the remote terminal apparatus needs to apply, or in a case that some or all of the conditions are determined not to be satisfied, then in step S1002, the operation may be, for example, applying a configuration including a configuration that the remote terminal apparatus needs to apply. Applying only the configuration that the remote terminal apparatus needs to apply may be applying a value provided by the RRC signalling or the system information to the T311 in the configuration of the special cell, for example. Applying a configuration including a configuration that the remote terminal apparatus needs to apply may be, for example, applying a value provided by the RRC signalling or system information to T301, T310, and T311 in the configuration of the special cell, and additionally or alternatively, may be configuring, in a case that the RRC signalling includes the dedicated configuration of the special cell, the special cell according to the dedicated configuration of the special cell, and additionally or alternatively, the BWP indicated by the ID may be considered to become an Active UL BWP in a case that the RRC signalling includes the dedicated configuration of the special cell and the dedicated configuration of the special cell includes a first active uplink BWP identifier (firstActiveUplinkBWP-Id), and additionally or alternatively, the BWP indicated by the identifier may be considered to become an Active DL BWP in a case that the RRC signalling includes the dedicated configuration of the special cell and the dedicated configuration of the special cell includes a first active downlink BWP identifier (firstActiveDownlinkBWP-Id).

Each of the T301, the T310, and the T311 may be a timer that may be configured for the UE 122. The operation of the UE 122 with respect to each of the timers described above is illustrated below. The UE 122 may initiate the T301 in a case of transmitting an RRC re-establishment request, may stop the T301 in a case of receiving an RRC re-establishment message or an RRC setup message, in a case of a selected cell or relay UE becoming unsuitable, and the like, and may enter RRC_IDLE in a case that the T301 expires. The UE 122 may initiate the T310 in a case of detecting a physical layer problem for a special cell, may stop the T310 in a case of receiving an RRC reconfiguration message including reconfiguration with synchronization IE, in a case of receiving a command indicating a handover from NR to another RAT, in a case of initiating a connection re-establishment procedure, etc., and in a case that the T310 expires, may enter RRC_IDLE, initiate an MCG failure information procedure, or initiate a connection re-establishment procedure, for example. The UE 122 may initiate the T311 in a case of initiating a connection re-establishment procedure, may stop the T311 in a case of selecting an appropriate cell or relay UE, or may enter RRC_IDLE in a case that the T311 expires.

An example of the embodiment in one aspect of the present invention will be described with reference to FIG. 10.

In a case of receiving the RRC signalling from the base station apparatus, the UE 122 determines a condition in step S1000, and performs an operation based on the determination in step S1002.

In step S1000, the condition may be, for example, a part or all of the following conditions.
(w-a) The UE 122 is acting as a remote terminal apparatus on a source side.
(w-b) After the RRC signalling is applied, the UE 122 is not configured with indirect path.

In the condition (w-a), the remote terminal apparatus may be an L2 U2N remote UE, an L3 U2N remote UE, or a terminal apparatus that communicates with a base station apparatus via a relay node. Determining that the condition (w-a) is satisfied may be determining that a relay-related configuration used by a remote terminal apparatus is applied to the UE 122, and additionally or alternatively, may be determining that a relay-related configuration used by a remote terminal apparatus has been applied to the UE 122, and additionally or alternatively, may be determining that an SRAP layer has been configured by the base station apparatus, and additionally or alternatively, may be determining that an SRAP layer has been configured by the RRC signalling, and additionally or alternatively, may be determining that the UE 122 is acting as a remote terminal apparatus. The condition (w-b) may be paraphrased as the indirect path being released by the RRC signalling, the indirect path being not configured after the RRC signalling is applied, the UE 122 is not acting as a multi-path remote terminal apparatus, or the like.

In a case that in step S1000, all the conditions are determined to be satisfied, the operation in step S1002 may be, for example, transmitting, to a higher layer (such as a ProSe layer), an indication to trigger release of the PC5 unicast link, or in a case that in step S1000, any of the conditions is determined not to be satisfied, the operation in step S1002 may be, for example, not transmitting, to the higher layer (such as the ProSe layer), the indication to trigger release of the PC5 unicast link. In a case of receiving the indication from the lower layer (such as the RRC layer) to trigger the release of the PC5 unicast link, the higher layer (such as the ProSe layer) may release the PC5 unicast link.

A remote terminal apparatus configured with a multi-path (that is, a multi-path remote terminal apparatus) may perform operations different from those of a remote terminal apparatus not configured with a multi-path. For example, in a case that the UE 122 receives an RRC message including a reconfiguration with synchronization IE from the base station apparatus, the UE 122 may not apply the ID (newUE-Identity) of the UE included in the reconfiguration with synchronization IE as a Cell-Radio Network Temporary Identifier (C-RNTI) in a case of determining that the UE 122 is acting as a remote terminal apparatus configured with a multi-path, and the UE 122 may apply the ID (newUE-Identity) of the UE included in the reconfiguration with synchronization IE as a C-RNTI, and in a case of determining that the UE 122 is acting as a remote terminal apparatus configured with no multi-path. Note that the multi-path remote terminal apparatus may be a terminal apparatus configured with a direct path and an indirect path. Note that, in a case that the base station apparatus transmits, to the UE 122, an RRC message including a reconfiguration with synchronization IE, and that the UE 122 is a multi-path remote terminal apparatus before and after the RRC message is applied, the base station apparatus may make the ID of the UE included in the reconfiguration with synchronization IE the same as the ID of the UE configured in the UE 122 immediately before the RRC message is transmitted.

The sidelink relay technology of the related art does not assume that the terminal apparatus is acting as a multi-path relay, and the terminal apparatus operates based on an inappropriate determination by performing the multi-path relay. One aspect of the present invention enables a reduction in unnecessary operations of the terminal apparatus and allows the terminal apparatus to perform operations to which signalling from the base station apparatus is appropriately applied.

In the above description, expressions such as “be indicated” and “receive an indication” may be replaced with each other.

In the above description, expressions such as “link”, “map”, and “associate” may be replaced with each other.

In the above description, expressions such as “included”, “being included”, and “was included” may be replaced with each other.

In the above description, “the” may be replaced with “above-described”.

In the above description, expressions such as “determined that”, “configured with”, and “including” may be replaced with each other.

In the example of each processing or the example of the flow of each processing in the above description, a part or all of the steps need not be performed. In the example of each processing or the example of the flow of each processing in the above description, the order of the steps may be different from each other. In the example of each processing or the example of the flow of each processing in the above description, a part or all of the processing in each step need not be performed. In the example of each processing or the example of the flow of each processing in the above description, the order of processing in each step may be different from each other. In the above description, “to perform B based on satisfaction of A” may be replaced with “to perform B”. In other words, “to perform B” may be performed independently of “satisfaction of A”.

Note that in the above description, “A may be interpreted as B” may include the meaning that B is interpreted as A in addition to interpretation of A as B. In a case that the above description contains “C may be D” and “C may be E”, this means inclusion of “D may be E.” In a case that the above description contains “F may be G” and “G may be H”, this may mean inclusion of “F may be H”.

In the above description, in a case that a condition “A” and a condition “B” are conflicting conditions, the condition “B” may be expressed as “other” condition of the condition “A”.

A program running on an apparatus according to the present embodiment may serve as a program that controls a Central Processing Unit (CPU) and the like to cause a computer to operate in such a manner as to realize the functions of the present embodiment. Programs or the information handled by the programs are temporarily loaded into a volatile memory such as a Random Access Memory (RAM) while being processed, or stored in a non-volatile memory such as a flash memory, or a Hard Disk Drive (HDD), and then read, modified, and written by the CPU, as necessary.

Note that the apparatuses in the above-described embodiment may be partially enabled by a computer. In this case, a program for implementing this control function may be implemented by recording the program in a computer-readable recording medium and causing a computer system to read and perform the program recorded in the recording medium. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically stores a program for a short period of time, such as a communication line in a case that the program is transmitted via a network such as the Internet or via a communication line such as a telephone line, and a medium that stores the program for a certain period of time, such as a volatile memory inside the computer system that is a server or a client in this case. Furthermore, the above-described program may be configured to realize some of the functions described above, and additionally may be configured to realize the functions described above, in combination with a program already recorded in the computer system.

Furthermore, each functional block or various characteristics of the apparatuses used in the above-described embodiments may be implemented or performed with an electric circuit, that is, typically an integrated circuit or multiple integrated circuits. An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or the processor may be a processor of known type, a controller, a micro-controller, or a state machine instead. The general-purpose processor or the above-mentioned circuits may include a digital circuit, or may include an analog circuit. Furthermore, in a case that with advances in semiconductor technology, a circuit integration technology appears that replaces the present integrated circuits, it is also possible to use an integrated circuit based on the technology.

Note that the present embodiment is not limited to the above-described embodiments. Although apparatuses have been described as an example in the embodiment, the present embodiment is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although the present embodiment has been described in detail above referring to the drawings, the specific configuration is not limited to the present embodiment and includes, for example, design changes within the scope that do not depart from the gist of the present embodiment. Furthermore, various modifications are possible within the scope of the present embodiment defined by claims, and embodiments that are made by suitably combining technical means disclosed according to the different embodiments are also included in the technical scope of the present embodiment. In addition, a configuration in which components, which are described in the embodiment described above, having similar effects are interchanged is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

100 ng-eNB
102 gNB
110, 112, 114 Interface
122 UE
200, 700 PHY
202, 702 MAC
204, 704 RLC
206, 706 PDCP
208, 708 RRC
210 PC5-S
310, 710 SDAP
400 Discovery
500, 600 Receiver
502, 602 Processing unit
504, 604 Transmitter
712 NAS
800 SRAP

1-3. (canceled)

4. A terminal apparatus configured to communicate with a base station apparatus, the terminal apparatus comprising:
reception circuitry configured to receive a radio resource control (RRC) message from the base station apparatus; and
processing circuitry, wherein
the processing circuitry is configured to configure a special cell in accordance with a dedicated configuration of the special cell included in the RRC message, based on a determination that one or both of two conditions are unsatisfied,
the dedicated configuration of the special cell corresponds to a configuration being for the special cell and a configuration dedicated to the terminal apparatus, and
the processing circuitry is configured to apply a value provided by the RRC massage to a timer T311, based on a determination that the both of two conditions are satisfied,
the two conditions are (a) the terminal apparatus is acting as a remote terminal apparatus, and (b) multi-path is not configured,
the multi-path being communication configuration in which a terminal apparatus communicates with a base station apparatus using a direct path and an indirect path,
the direct path being a path through which the terminal apparatus directly communicates with the base station apparatus via the Uu interface,
the indirect path being a path through which the terminal apparatus communicates with the base station apparatus via a relay terminal apparatus.

5. A method of a terminal apparatus for communicating with a base station apparatus, the method comprising the steps of:
receiving a radio resource control (RRC) message from the base station apparatus; and
configuring a special cell in accordance with a dedicated configuration of the special cell included in the RRC message, based on a determination that one or both of two conditions are unsatisfied, wherein
the dedicated configuration of the special cell corresponds to a configuration being for the special cell and a configuration dedicated to the terminal apparatus, and
applying a value provided by the RRC massage to a timer T311, based on a determination that the both of two conditions are satisfied,
the two conditions are (a) the terminal apparatus is acting as a remote terminal apparatus, and (b) multi-path is not configured,
the multi-path being communication configuration in which a terminal apparatus communicates with a base station apparatus using a direct path and an indirect path,
the direct path being a path through which the terminal apparatus directly communicates with the base station apparatus via the Uu interface,
the indirect path being a path through which the terminal apparatus communicates with the base station apparatus via a relay terminal apparatus.

6. An integrated circuit implemented in a terminal apparatus for communicating with a base station apparatus, the integrated circuit comprising:
a function of receiving a radio resource control (RRC) message from the base station apparatus; and
a function of configuring a special cell in accordance with a dedicated configuration of the special cell included in the RRC message, based on a determination that one or both of two conditions are unsatisfied, wherein
a function of applying a value provided by the RRC massage to a timer T311, based on a determination that the both of two conditions are satisfied,
the dedicated configuration of the special cell corresponds to a configuration being for the special cell and a configuration dedicated to the terminal apparatus, and
the two conditions are (a) the terminal apparatus is acting as a remote terminal apparatus, and (b) multi-path is not configured,
the multi-path being communication configuration in which a terminal apparatus communicates with a base station apparatus using a direct path and an indirect path,
the direct path being a path through which the terminal apparatus directly communicates with the base station apparatus via the Uu interface,
the indirect path being a path through which the terminal apparatus communicates with the base station apparatus via a relay terminal apparatus.
